(19) United States
(12) Patent Application Publication
(10) Pub. No.: US 2013/0096937 A1
(43) Pub. Date: Apr. 18, 2013

(54) MEDICAL PROVIDERS KNOWLEDGE BASE AND INTERACTION WEBSITE

(71) Applicants: Edward Robert Campbell, Honolulu, HI (US); ErIan S. Toulegenov, Redmond, WA (US)

(72) Inventors: Edward Robert Campbell, Honolulu, HI (US); ErIan S. Toulegenov, Redmond, WA (US)

(21) Appl. No.: 13/645,120

(22) Filed: Oct. 4, 2012

Related U.S. Application Data
(60) Provisional application No. 61/543,091, filed on Oct. 4, 2011.

(51) Int. Cl. G06F 19/00

(52) U.S. Cl. CPC G06F 19/32
USPC 705/2

(57) ABSTRACT

One or more webpages are presented to convey a medical provider's knowledge base and interaction website. The website maintains and displays information regarding multiple medical providers and a user of the website may search the knowledge base regarding the medical providers. A counter keeps track of 1) a total number of specific medical procedures performed by each medical provider, 2) the number of specific medical procedures performed by each medical provider per set period of time, 3) the total number of specific diseases treated by each medical provider, 4) the number of specific diseases each medical provider has treated per set period of time, and 5) any combination of these. The specific medical procedures and the specific diseases treated are searchable criteria in a search routine implemented on the website as well as displayed information on one or more web pages regarding each medical provider in the multiple medical providers.

### RELATED APPLICATIONS

This application claims the benefit of and priority to, under 35 U.S.C. 119, US provisional patent application titled, “A medical providers knowledge base and interaction website,” Ser. No. 61/543,091, filed Oct. 4, 2011.

### NOTICE OF COPYRIGHT

A portion of the disclosure of this patent document contains material that is subject to copyright protection. The copyright owner has no objection to the facsimile reproduction by anyone of the interconnect as it appears in the Patent and Trademark Office Patent file or records, but otherwise reserves all copyright rights whatsoever.

### FIELD

An embodiment relates to providing a way of verifying, storing, and utilizing medical information in a platform accessible by many different organizations and people.

### BACKGROUND

The most common way to find a good doctor is to ask friends about their own experience with doctors. Prior to be seen by a doctor, patients may do an Internet search about the doctor and the disease. A number of websites provide information about doctors but lack credibility or relevant information.

### SUMMARY

A number of apparatus and methods are described for a medical provider's knowledge base and interaction website. In an embodiment, a computer-implemented method is executed in a client-server environment. One or more web pages are served to one or more clients connected over a network to a host server in order convey a medical provider's knowledge base and interaction website in the one or more web pages. The medical provider's knowledge base maintains and displays information regarding a plurality of medical providers. A search functionality is scripted on the data contained in the medical provider's knowledge base, where a user of the website may search the knowledge base regarding the plurality of medical providers. A software routine, hardware device, or combination of the two keeps track of 1) a total number of specific medical procedures done by each medical provider in the plurality of medical providers, 2) a number of specific medical procedures done by each medical provider per set period of time, 3) a total number of specific diseases treated by each medical provider, 4) a number of specific diseases each medical provider has treated per set period of time, and 5) any combination of these. The specific medical procedures and the specific diseases treated are searchable criteria in a search routine implemented on the website as well as displayed information on one or more webpages regarding each medical provider in the plurality of medical providers. The website and its functionality may be implemented with coded software, hardware circuits, and any combination of both. Any portions of the website and its functionality implemented in coded software are stored in a non-transitory computer readable medium in format executable by a processing component.

### BRIEF DESCRIPTION OF THE DRAWINGS

The multiple drawings refer to the embodiments of the invention.

FIG. 1 illustrates an embodiment of a home page of the medical provider's knowledge base and interaction website that is scripted to provide tabs and links to perform the functions herein.

FIG. 2 illustrates an embodiment of the About Us tab page and/or a help tab page which gives explanations about the website, the company, and on how to use the website.

FIGS. 3A and 3B illustrate embodiments of web pages presented by selecting the Choose MD or Find MD tab.

FIG. 4 illustrates an embodiment of the medical provider review web page.

FIGS. 5A and 5B illustrate embodiments of example search results pages showing the list of medical providers returned based on the search criteria selected by the user along with the data for the various criteria.

FIG. 6 illustrates an embodiment of a search results page showing a comparison the medical providers and average patent survey results to be displayed to a user.

FIGS. 7A and 7B illustrate embodiments of the medical providers published profile page to the public on the website.

FIGS. 7C-7F illustrate embodiments of web pages showing various graphs showing or comparing the results of the survey in a given span of time as well as potentially comparing other criteria.

FIG. 8 illustrates an embodiment of a medical provider sign on web page.

FIG. 9 illustrates an embodiment of an online scheduling calendar presented by a web page to make an appointment.

FIG. 10 illustrates an embodiment of a patient data input web page.

FIG. 11 illustrates an embodiment of a medical provider's office data input page.

FIG. 12 illustrates an embodiment of an example questionnaire page presented to a user/patient after the security code has been validated.

FIG. 13 illustrates an embodiment of a page presented to a call center.

FIG. 14A illustrate an embodiment of a patient's account page.

FIG. 14B illustrates a chart of some example premium services.

FIG. 15 illustrates a block diagram of an example computing system that may use an embodiment of one or more of the software applications discussed herein.

FIG. 16 illustrates a diagram of a network environment in which the techniques described may be applied.

While the invention is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the invention.

### DETAILED DISCUSSION

In the following description, numerous specific details are set forth, such as examples of specific routines, named components, connections, types of servers, etc., in order to provide a thorough understanding of the present invention. It will be apparent, however, to one skilled in the art that the present invention may be practiced without these specific details. In other instances, well known components or methods have not been described in detail but rather in a block diagram in order to avoid unnecessarily obscuring the present invention. Thus, the specific details set forth are merely exemplary. The specific details may be varied from and still be contemplated to be within the spirit and scope of the present invention.

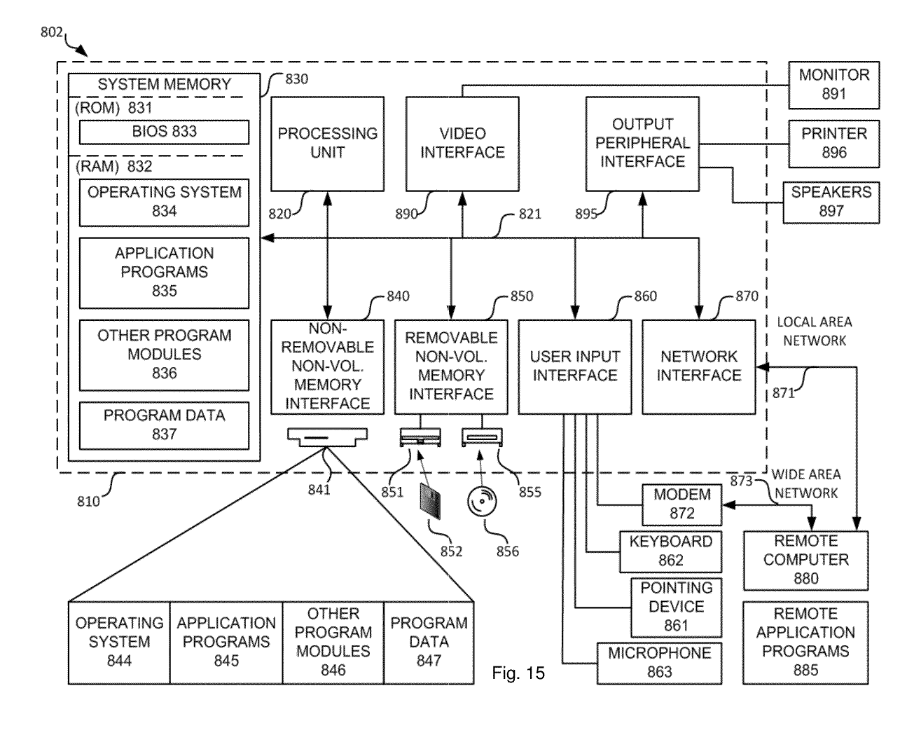

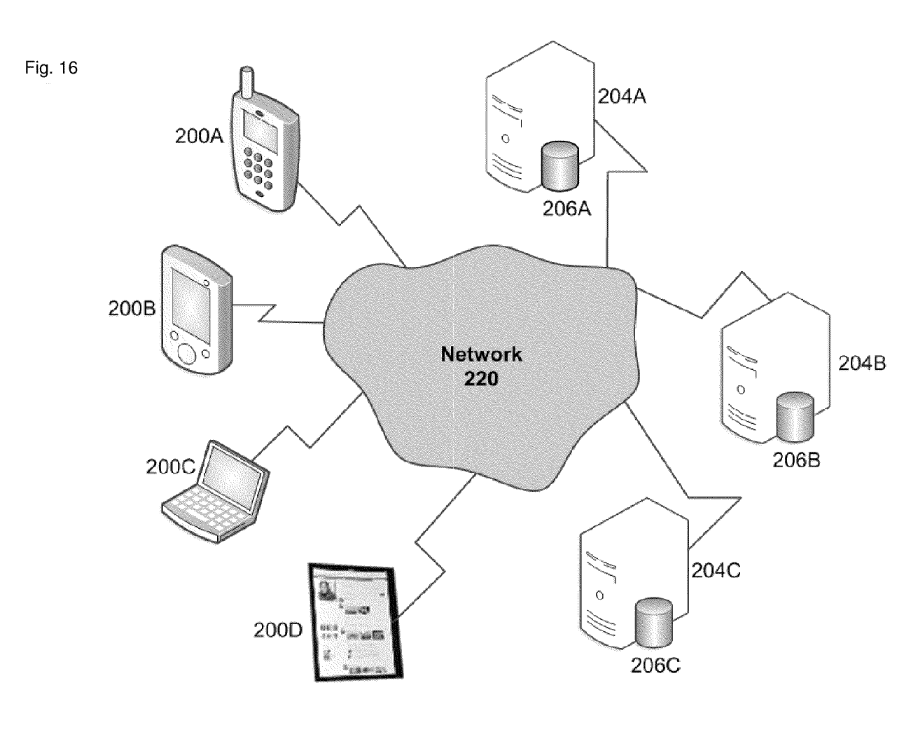

Example processes for and apparatuses to provide a medical providers' knowledge base and interaction website are described. The following drawings and text describe various example implementations of the design. FIG. 15 and FIG. 16 illustrate example environments to implement the concepts. A website consisting of one or more webpages hosted on one or more servers 204A-204C are configured to convey a medical provider's knowledge base and interaction website. The website is configured to maintain and display information regarding a plurality of medical providers to a number of client devices 200A-200D and a user of the website via a browser of a client device may search the knowledge base 206A-206C regarding the plurality of medical providers.

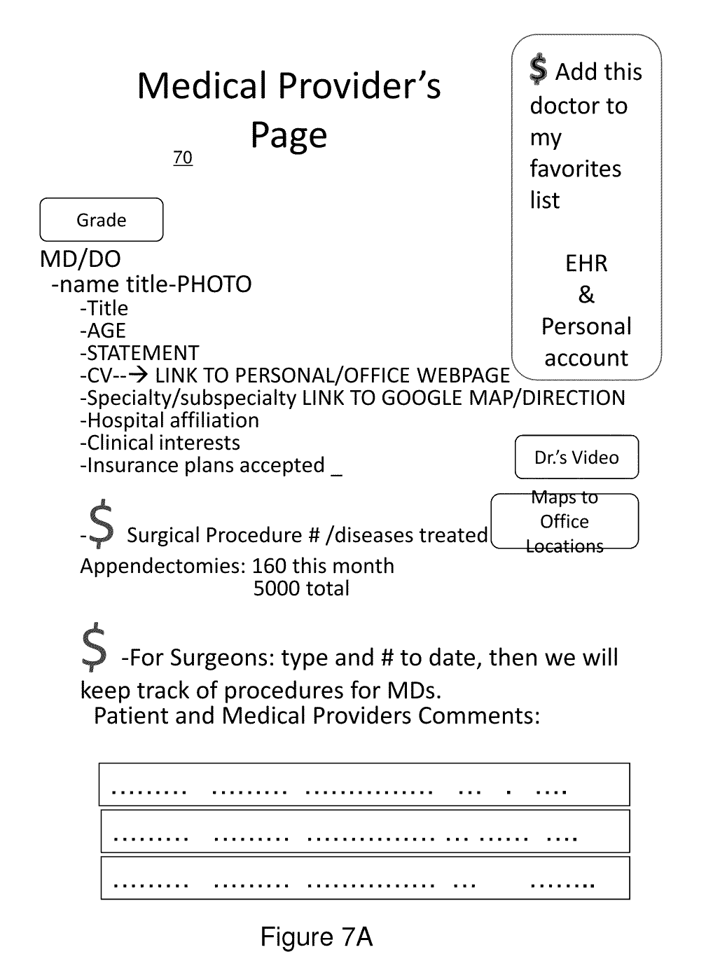

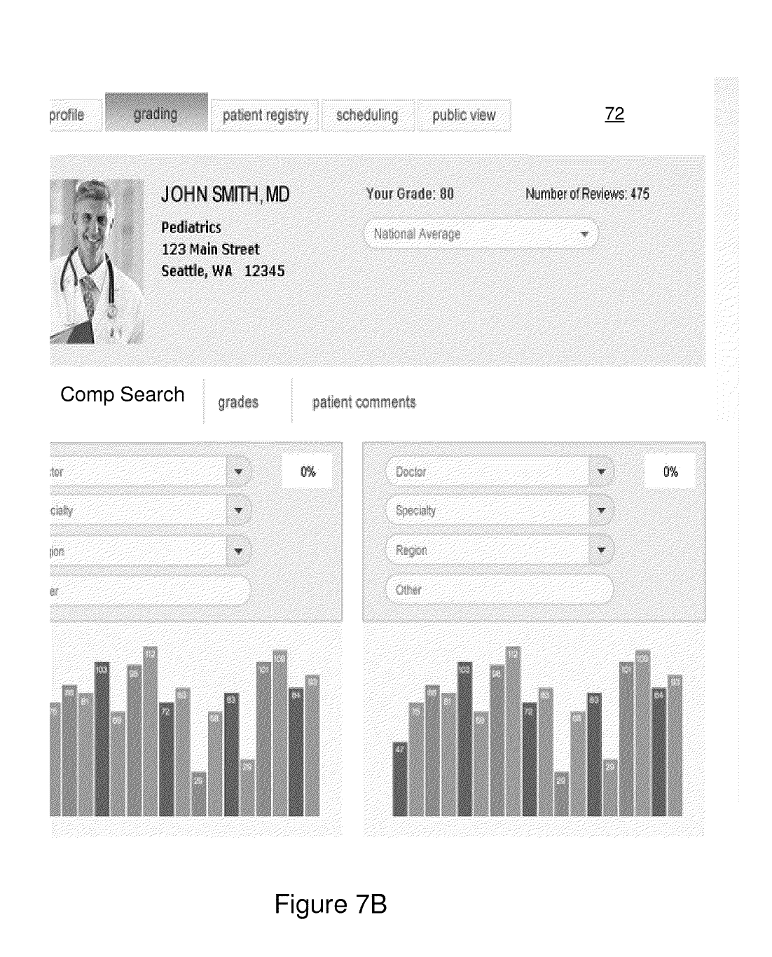

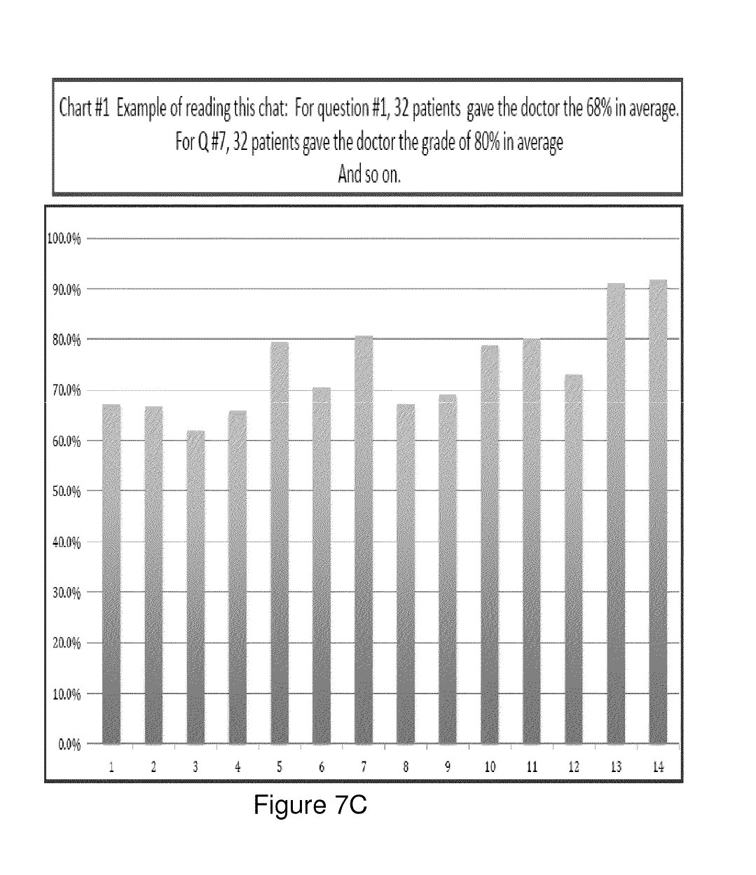

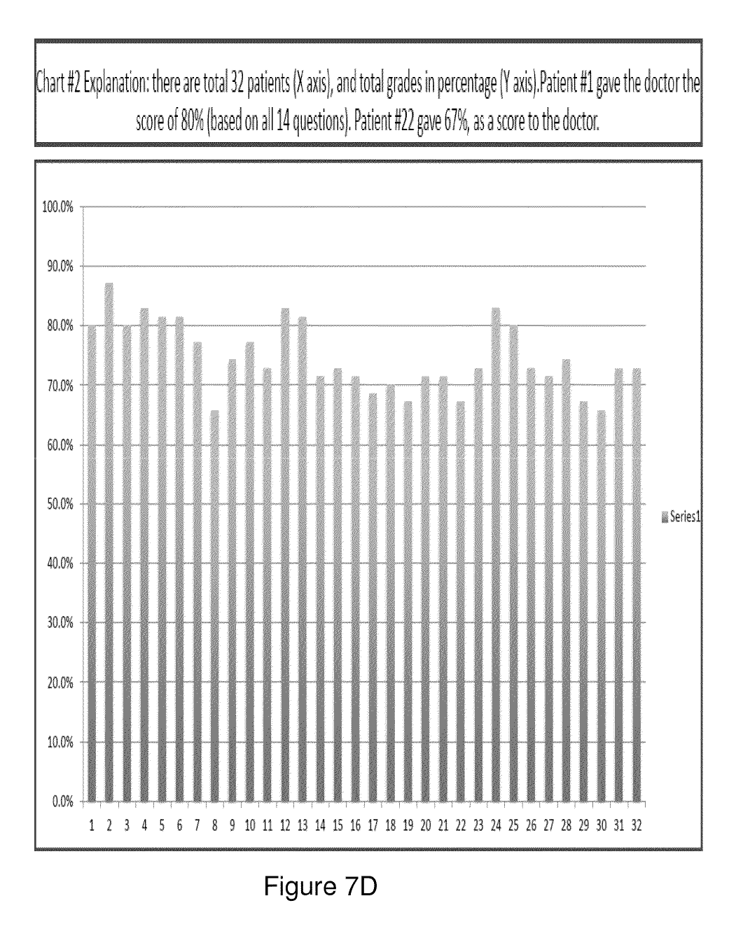

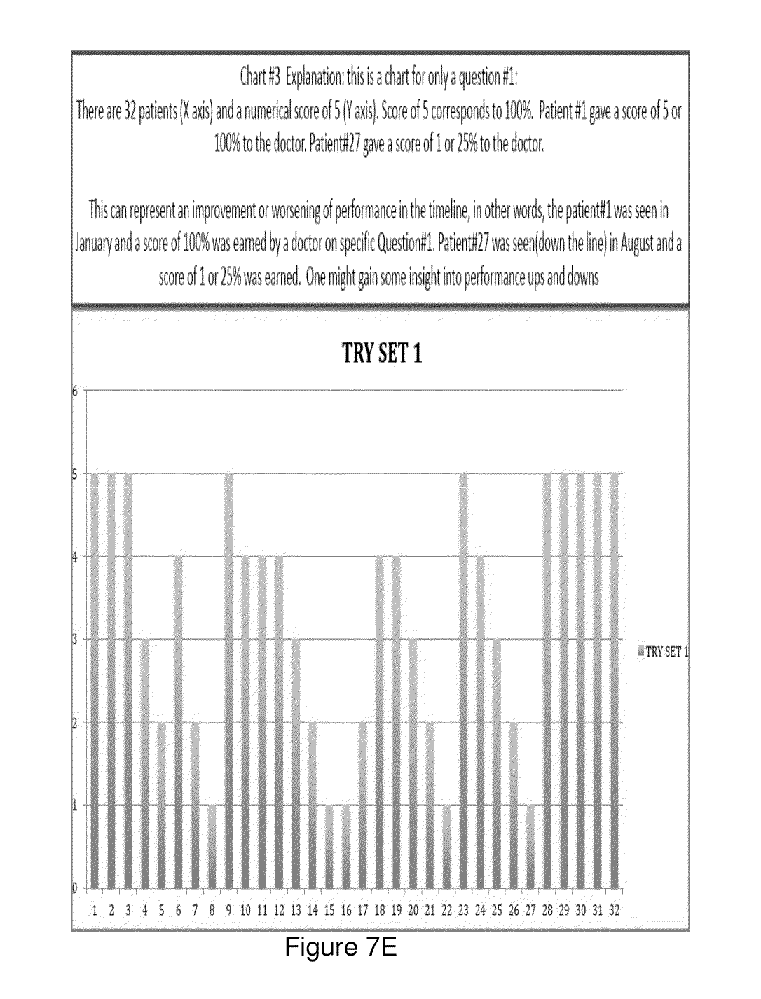

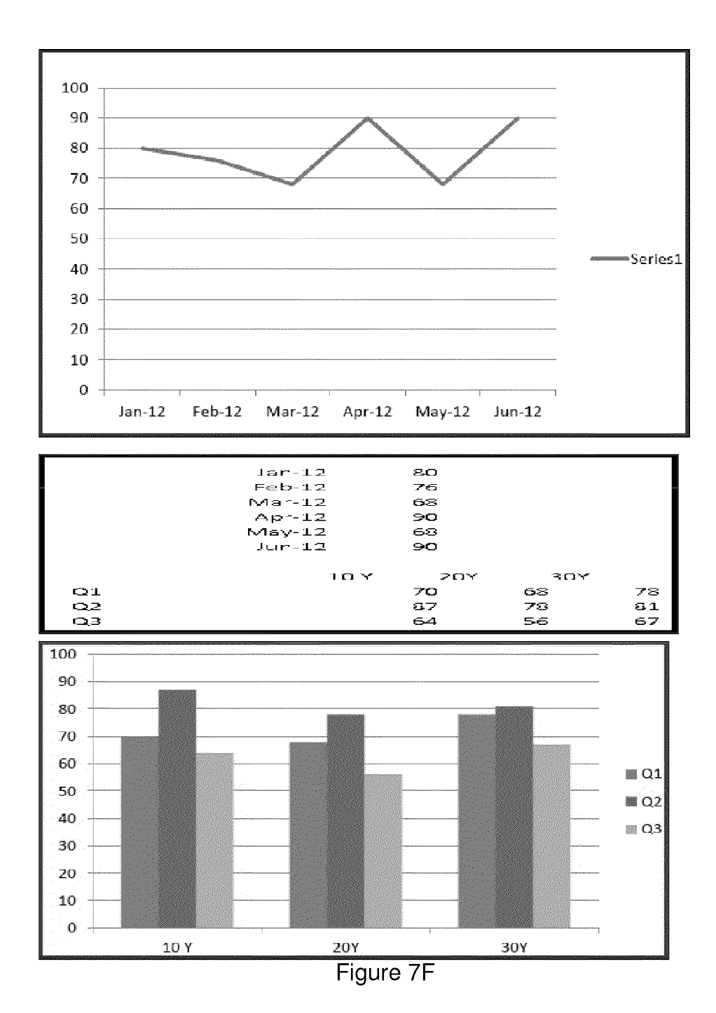

As discussed, prior to being seen by a doctor, patients may do an Internet search about the doctor and the disease. The medical providers knowledge base and interaction website provides information about doctors including research on the about their doctors' health services and business practices. This system of one or more servers 204A-204C mirroring the website cooperating with one or more databases 206A-206C hosts the medical provider's knowledge base and interaction website. The one or more servers 204A-204C serve web pages providing numerous beneficial functions to a client device 200A-200D with a resident browser program. The medical provider's knowledge base and interaction website is scripted to provide many functions including but not limited to:
1. Accumulating verified patient reviews.
2. Ranking/Scoring of medical providers: Physicians (M.D., D.O.), Dentists (D.M.D), Chiropractors, Veterinary doctors, and other similar providers based on these verified patient reviews.
3. Keeping a track of a number of specific procedures done by each medical provider listed in the website.
4. Keeping a track of a number of specific diseases the provider has treated.
5. Sending each medical provider emails, text messages or other communication on a weekly or biweekly or monthly as desired with an overview of the results from the patient reviews.
6. Giving each medical provider time to give a rebuttal against negative comments, as well as a selectable set of some pre-typed out appreciative comments to positive patient comments.
7. When patients search for a doctor indicating a specific disease, this disease can be included in their profile as a current medical history. The profile is a part of Personal Medical Record (PMR). The PMR can include a list of allergies, list of surgeries, list of medications, list of all doctors patient had seen in the past, which is all useful when filling in certain documents (i.e. applications for: Medical Insurance, Disability Insurance, Life Insurance;) or for medical providers), and list of pharmacies where medications are filled. All the above is useful not only for patients but also for family members (children of elderly parents will find this bank of information very useful). In a way, a patient's account on the website is a bank of the patient's medical profile.
8. Medical providers will be able to review in detail in graph or tabular view the results of the survey in the span of time (1 mo, 3 mo, 6 mo, 12 mo) over time similar to financial stock analysis. Please see attached examples of graphs in FIGS. 7B-7F.
9. And, many more features discussed herein.

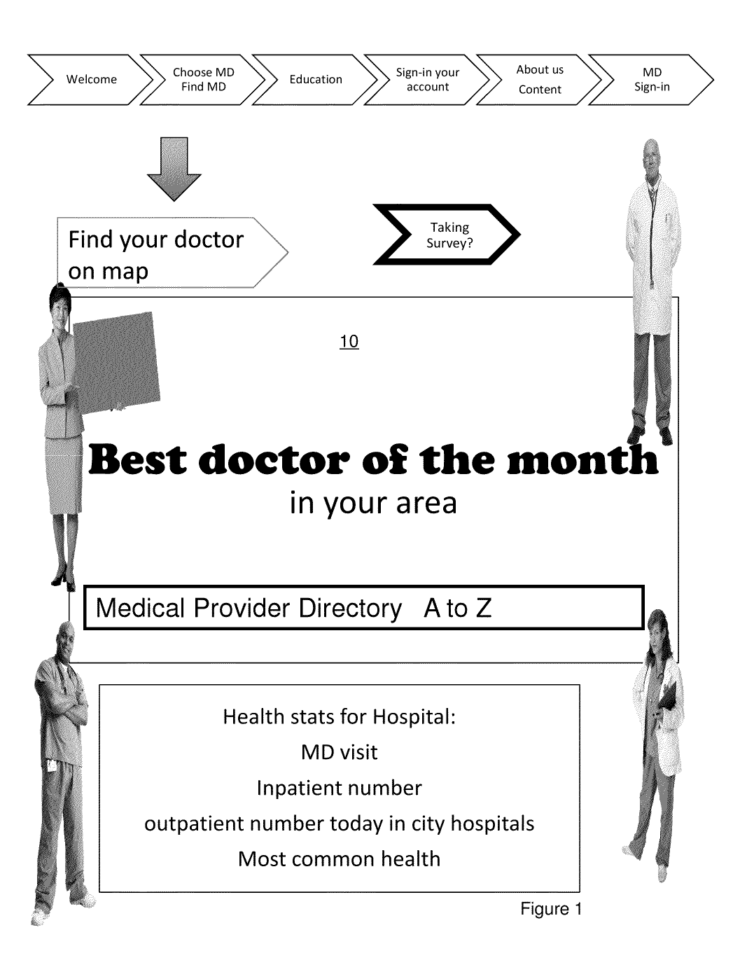

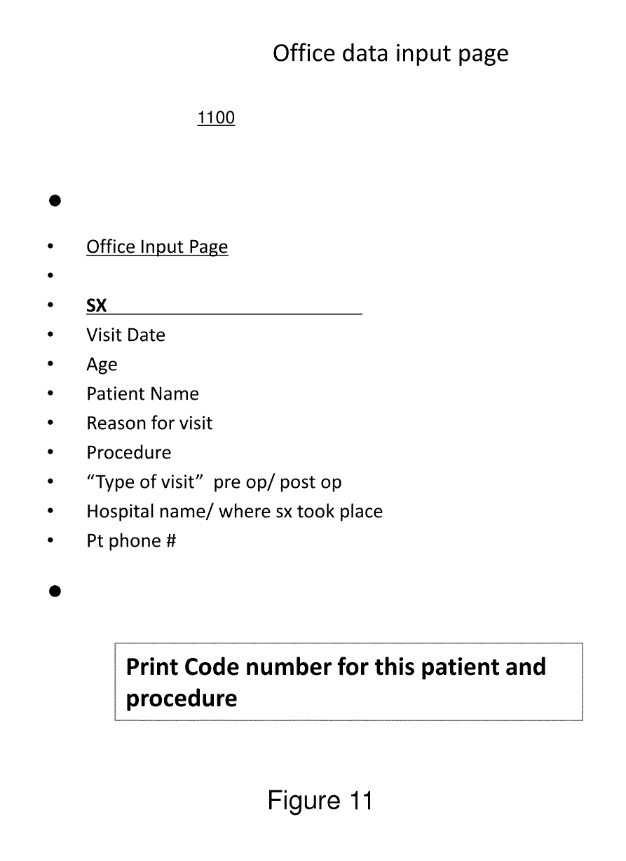

FIG. 1 illustrates an embodiment of a home page of the medical provider's knowledge base and interaction website that is scripted to provide tabs and links to perform the functions herein. For example, the home page 10 presents tabs with links such as Welcome, Choose MD or Find MD, Education, Sign into your account, About us, MD sign in, etc. The home page 10 of the website may list the total number of hospitalized patients in given city by hospital. It can be compared to another large city (NYC, San Fran, LA, etc.). The home page 10 also may have a Video about the website and its uses. The home page 10 also may list a selected medical provider that has a high ranking with an award or a title based on being the best ranking, by hospital, area, state, weekly, monthly, etc. The homepage 10 also includes 1) a small field where patients can enter their randomly assigned code (patients received it in doc's offices after the appointment) or 2) click on survey hyperlink, in order to be brought to the separate webpage to complete a review of the last office visit. Note, the doctor's office itself may be used as the originating source to give the survey with its unique assigned code to a patient who has indeed was seen and serviced by that doctor. However, the system is also configured with Application Interfaces to take in information on patients who have seen a doctor and use the processes herein to collect the survey information from the patient from other originating sources, such as Hospitals themselves providing the patients' information and insurance companies providing the patients' information securely to our website and then the survey questionnaire being sent to the patient. Thus, a second example manner of patient input is to receive patients' list and encounters from insurance companies, hospital or health organizations. The patients' list will be inputted to the system via the administrator web page (for example, see FIG. 11). If the website is supplied with the email address of the patient, then the website scripts can send a patient email with a secure link to our website where they can complete a survey. Other methods are described later as well to collect survey information.

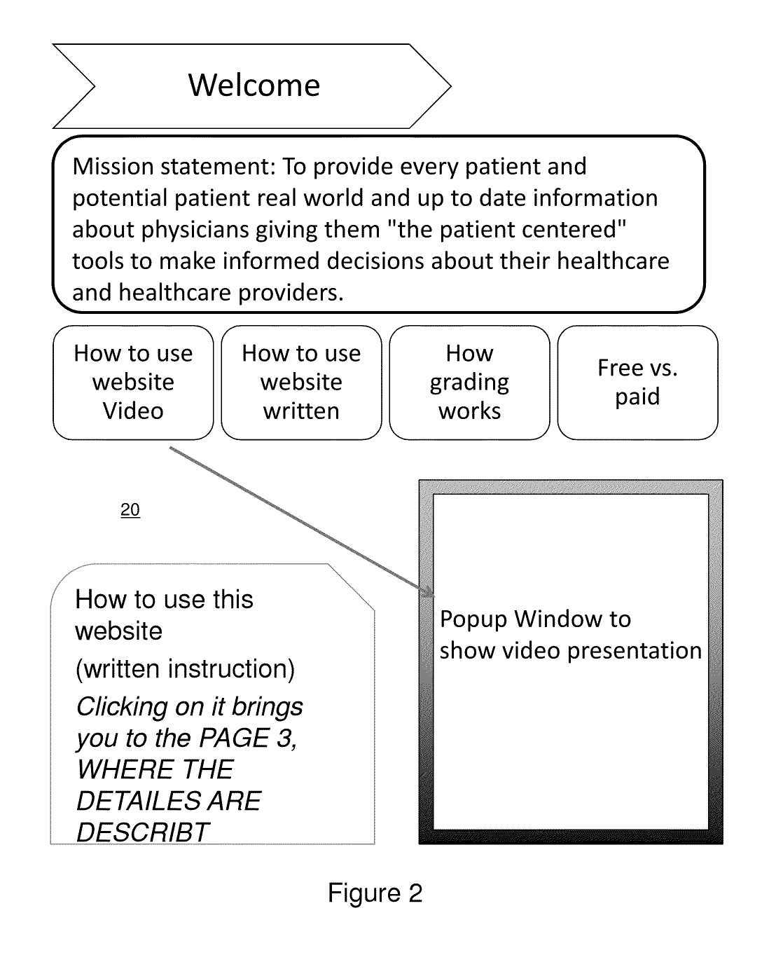

FIG. 2 illustrates an embodiment of the About Us tab page and/or a help tab page 20 which gives explanations about the website, the company, and on how to use the website. Alternatively, like all of these pages many hyperlinks links exists and when a user/patient clicks on the Welcome tab and then scrolls to the Patients tab their browser is brought to this page. The medical providers' knowledge base and interaction website is scripted to provide every patient and potential patient real world and up to date information about medical providers, giving them “the patient centered” tools to make informed decisions about their healthcare and healthcare providers. The medical providers' knowledge base and interaction website is designed to be a fast, easy, and reliable source of medical provider search capability and research on that medical provider.

The page 20 may contain a Mission statement; an explanation how to use the service, tutorial of how choose doctor or how to fill in surveys; how the website verify patients and medical providers information; a FAQ of use of website; Testimonials; and potential patient health questions being answered by any doctor who is willing to participate in that patient-doctor forums. Registered patients, medical providers, and other can log in with their user name and password.

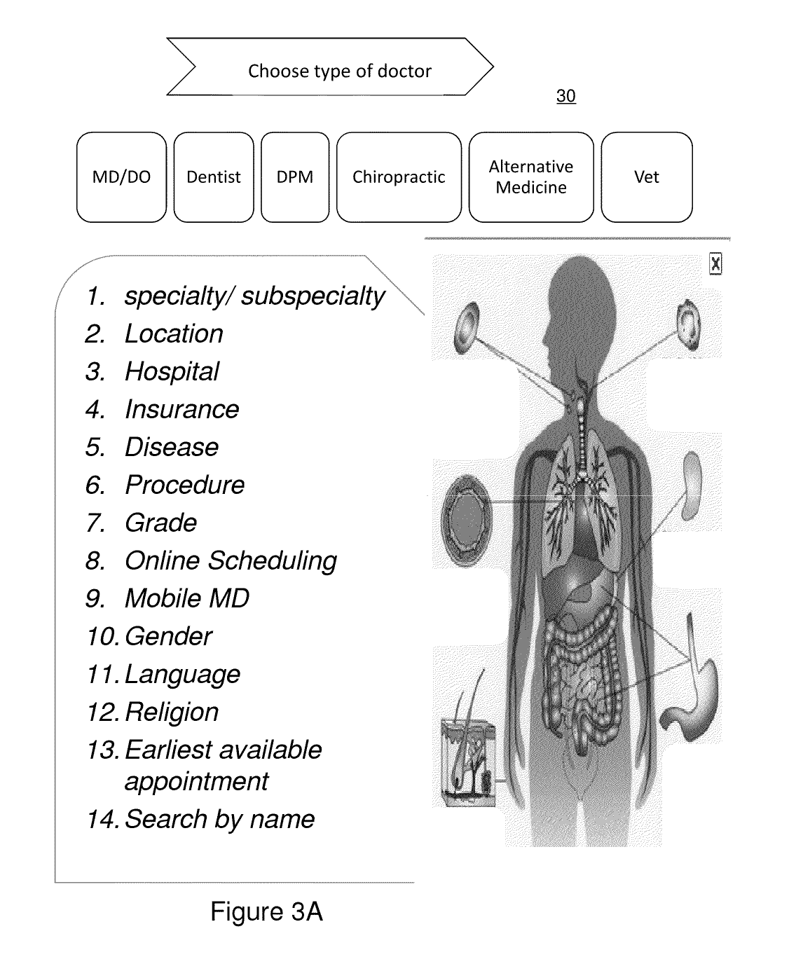

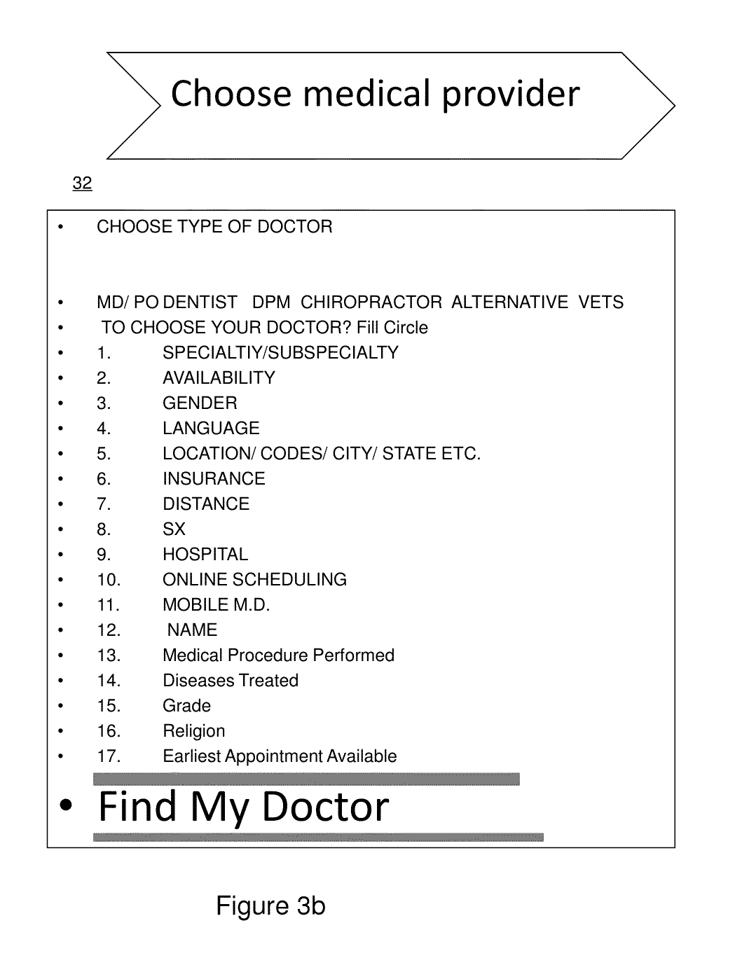

FIGS. 3A and 3B illustrate embodiments of web pages presented by selecting the Choose MD or Find MD tab. Multiple tabs are linked to find medical providers in different fields as medicine such as a dentist, a medical doctor, a chiropractor, etc. The website's easy-to-use interface and powerful tools allow patients to find and connect with the medical professionals who can best meet their needs. Users can filter their searches by location, specialty, accepted health insurance plans, and other highly-specific criteria. Thus, specific criteria about that doctor type may be factored into the search such as specialty, geographic location, hospital affiliation, insurance coverages accepted, etc. The user of the web page 30, 32 is allowed to order the ranking of these search criteria to influence the resultant search for the medical provider. This user may simply drag the various criteria to create the order, mouse click/fill in a circle by criteria of importance, and/or respond to a pop up window, or some other similar mechanism to rank and order the importance of these criteria in finding the right set of medical providers as a result of this query. Depending on the ranking of these criteria by the user, the query result as discussed later will be displayed to the user on the web page. Thus, the medical providers' knowledge base and interaction website is scripted to provide a best match between a potential patient's needs, including at least 1) customer service rating of the medical provider and customer comments, 2) ability for home visits by the medical provider, 3) insurance accepted by the medical provider, 4) overall ranking of the medical provider, 5) medical skills of the medical provider including the doctor's specialty and the number of specific medical procedures performed and diseases treated, 6) gender of the medical provider, 7) online appointment availability to see the medical provider, 8) location of the medical provider's facility, 9) religion of the medical provider, 10) human languages spoken at the medical provider's facility, 11) Years of practice by the medical provider, and 12) any combination of at least three of these criteria, to one or more medical provider's from the plurality who hold the skills required to address the user's problem. The search can be based on, for example, any, some, or all of the eighteen or so criteria given as examples discussed herein. The medical procedures performed and diseases treated gives the ability to match a patient's medical condition to a medical provider's actual experience.

Another feature on this page 30 is an interactive human anatomy illustration as shown in FIG. 3A, in which users may select areas that are hurting/need medical consultation on the interactive human anatomy illustration and a pop up wizard will present questions to guide the user to find the type and specialty of a doctor who the user should make an appointment with. Thus, the medical providers' knowledge base and interaction website is configured to present a web page 30 with a feature of an interactive human anatomy illustration, in which users may select areas that are hurting or need medical consultation on the interactive human anatomy illustration. Next, a pop up wizard can present questions to guide the user to find a type and specialty of the medical provider who the user should 1) make an appointment with, 2) types of medical providers in the plurality of medical providers to perform a search on and then populates at least a portion of the search criteria with the known information about the user and information obtained from the interaction with the interactive human anatomy illustration, and 3) any combination of the two.

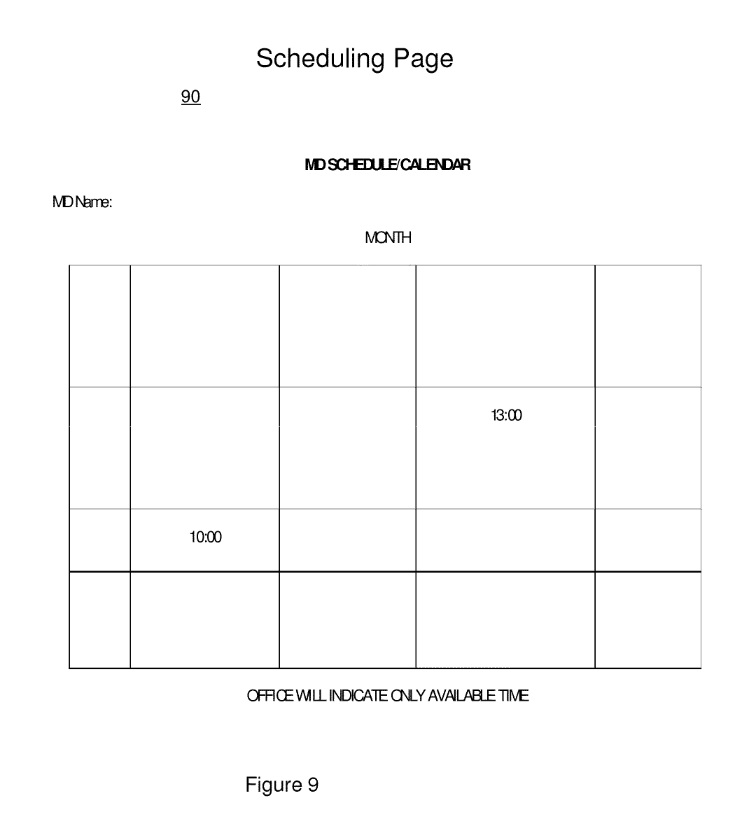

With the more standard fill-in-a-field based search or the human anatomy search, for patients searching for the providers, the medical provider's knowledge base and interaction website is scripted to allow the potential patient to select a physician based on these criteria. Patients will then be offered a list of doctors to choose from. Each doctor's name on the search results list is linked to their description webpage (the content of this page is discussed later in FIGS. 7A and 7B). As an end-point result of this process, patients are linked to online scheduling calendar to make an appointment (see FIG. 9). The above process is designed to achieve the best match between a patient's needs including customer service, ability for home visits and medical skills of the medical provider, and a medical provider who holds the skills required to address patient's problem.

The medical providers' knowledge base and interaction website is scripted to have a search engine which searches a database for the website to provide a search for an appropriate specialist. The search can be based on, for example, 3 to 18 criteria. Note, not all criteria must be selected in order to gain results of the search.

Example Search Criteria:
1. Specialty/subspecialty (the master list of all specialties/subspecialties is maintained by the database and then matched to individual physician's record by a search engine);
2. Location (Google Mapped, needs to be discussed with Google.com or Microsoft Bing Map);
3. Hospital (the master list is maintained by the database and then matched by a search engine);
4. Insurance (the master list is maintained by the database and then matched by a search engine);
5. Diseases treated (the master list is maintained by the database and then matched by a search engine);
6. Medical Procedures performed (the master list is maintained by the database and then matched by a search engine);
7. Grade/Rating (Extrapolated from patients' answers by the website's algorithm);
8. Online Scheduling (this refers to the fact whether doctor's office is able to provide online scheduling or not, i.e. YES vs. NO);
9. Mobile MD (where the medical provider travels to see the patient). For certain medical diseases, the medical providers' knowledge base and interaction website is scripted to introduce the searchable feature of house calls by local physicians. Those physicians, who sign up to provide such service, will be highlighted when their name comes up among resulting search list of physicians. This type of service allows Internal Medicine or Family Practice physicians to win over new patients. It is a searchable criterion that is important to some sectors of potential patients.
10. Gender (taken off the physician's site/profile);
11. Human Languages spoken (taken off the physician's site);
12. Religion (taken off the physician's site);
13. Earliest available appointment (depending whether doctor office signs up for it, but this option of on-line scheduling criteria is applied to every office);
14. Search by name (Master list of every physician by state is downloaded with their respective addresses) or NPI (National Provider Identifier) or License number.

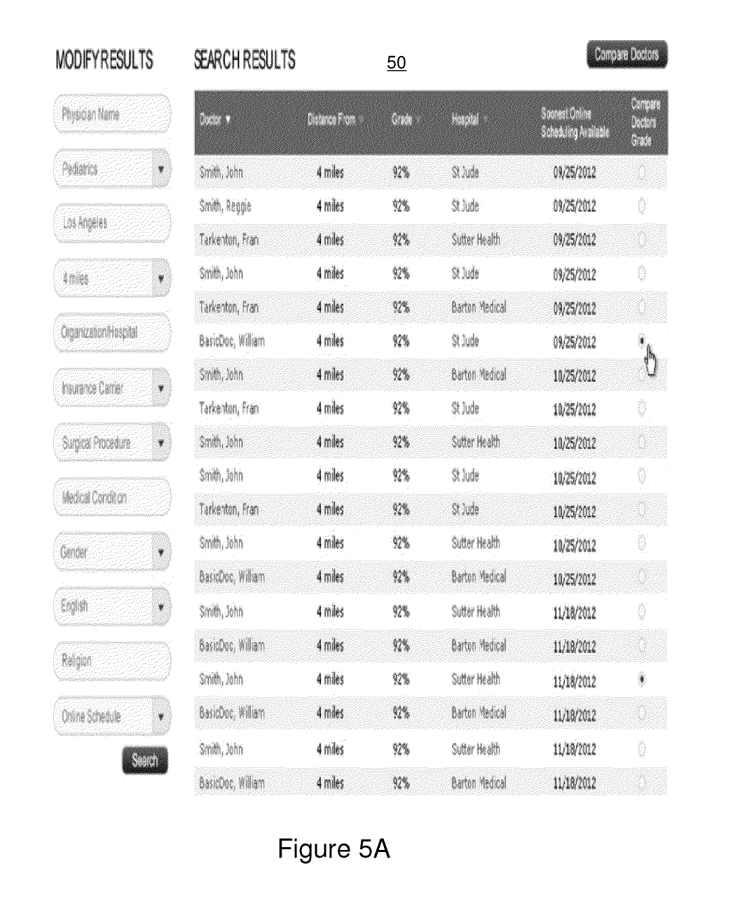

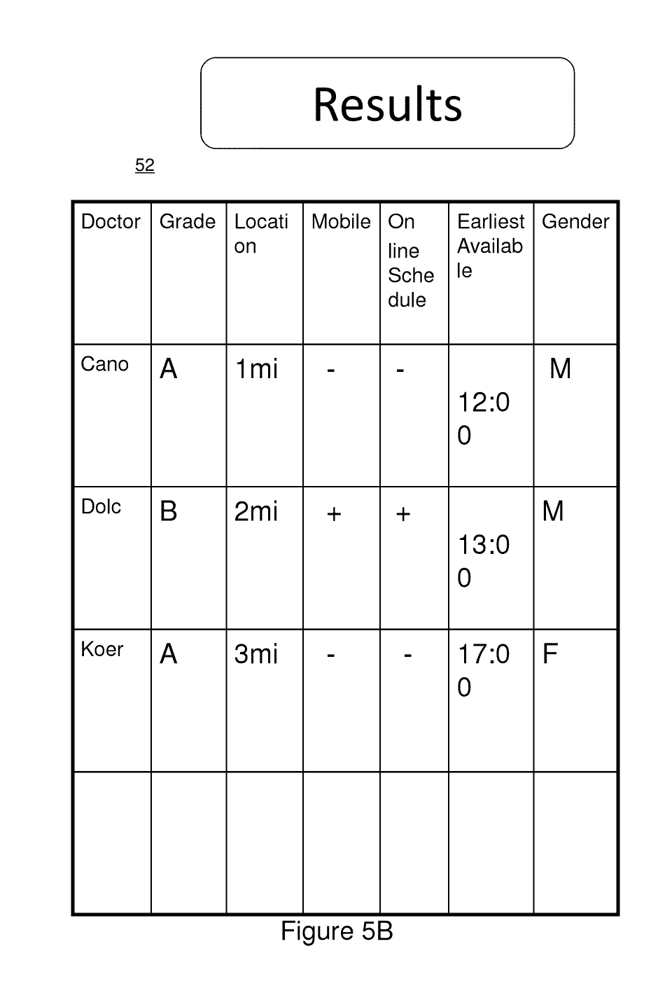

The search results can be displayed in table format with a resulting list of medical providers (progressive or regressive manner) on the left with horizontal list of criteria displayed on the top (see for example FIGS. 5A and 5B). For instance, the medical provider with the best rating and most closely matched desired criteria would be the first one on the list. Or if the medical provider is a paid member, the search engine can affect the search results to place the medical provider closer to the top of the list. The medical provider's name is linkable to his/her webpage on the website.

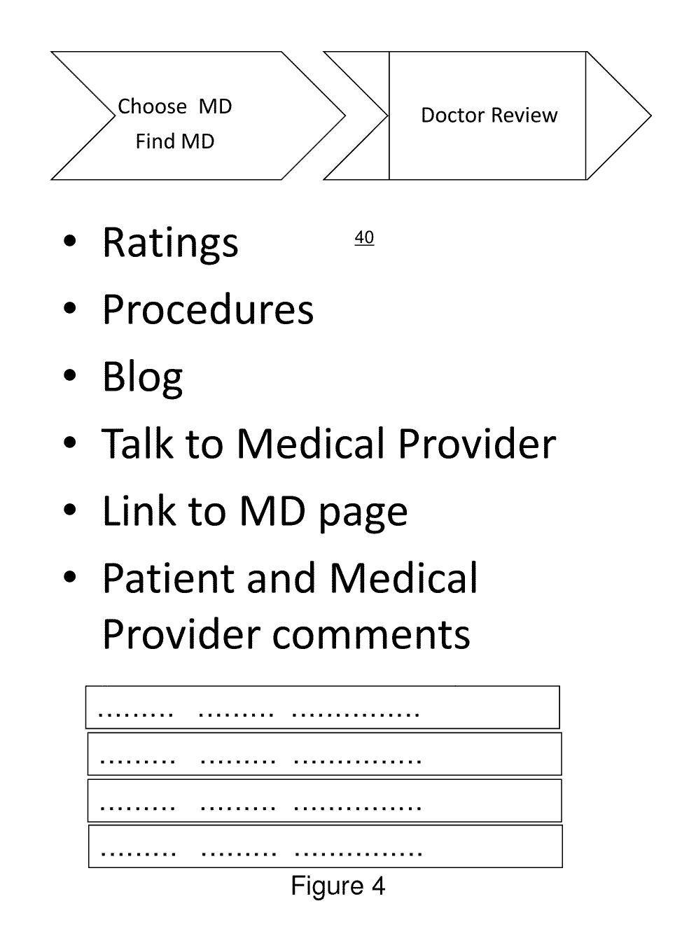

FIG. 4 illustrates an embodiment of the medical provider review web page 40. The medical providers' knowledge base and interaction website is scripted to provide accumulated verified patient reviews of a medical provider that are displayed on this web page 40. The server system for this medical providers' knowledge base and interaction website hosts and serves web pages for aggregate reviews of physicians and publishes those reviews. The medical providers' knowledge base and interaction website takes in and presents patients reviews. These verified patient reviews affect the grade and ranking of the medical provider.

The website assigns unique codes to verify that merely a select qualified group of people, i.e. actual patients of the medical provider are providing the patient review information. The patients of the medical providers fill out the service experience questionnaire, on-line, over the phone, or mail in. To control whom is filling out these forms and keep the data providers as a select qualified group to provide data, each time a unique security code is given for that specific service experience questionnaire, which is also matched to a list of currently active codes in a database on the hosting site to verify the data providers are in fact the select qualified group desired to provide data. The medical providers' knowledge base and interaction website tends to eliminate fake reviews by physicians, competition, or whoever acting on their behalf. This allows the public in general to trust this third party website of the medical providers' knowledge base and interaction website to provide more truthful and/or reliable information. The reviews come from the patients of the physician and not from a competitor or someone who has not been serviced by the medical provider. The surveys with the special unique security codes are generated by the website and then are distributed to the patients from the physician's office itself to ensure patients are providing the survey information. In addition, the physician's office itself fills out what the condition was treated and the procedures performed to increase the accuracy of the survey as well as allow the administrators of the website to follow up with known patients who have recently seen the physician to obtain the survey data but not necessarily be made privy to what the actual condition treated was and the procedures performed.

The medical provider is given a period of time after a patient review comes in to look over the review and post a rebuttal comment before the patient review is posted on-line. Content analyzing software may review the content from the patient review and when the Content analyzing software detects the negative comments as well as low scores, and then a routine in the software will generate an e-mail or SMS text message to the treating medical provider notifying the medical provider of the unfavorable review. The software may also generate popup window to alert the provider to the unfavorable review the next time the medical provider logs into the website. The medical providers knowledge base and interaction website will post the actual patient review but holds back publishing that review for a specific duration such as 10 business days to give the medical provider a chance to review the patient review and generate a rebuttal/explanation/thank you for the review that will publish for the first time at the same time when the patient review publishes on the website.

A survey manager module of the website is scripted to provide everything to manage the onsite and online patient survey feedback. From survey design to interactive web reporting, all management tasks are accomplished through the survey manager's intuitive interface. The medical providers' knowledge base and interaction website is not merely a place where one can rant or praise their medical provider or a hospital but a platform where patients relate their experience in organized manner answering the standard set of survey questions. The website does support a blog where some additional community conversation may take place.

Generally, regarding the nature of patient reviews found on the Internet, they are inconsistently skewed either to be overwhelmingly positive or negative; and thus, are insufficiently reflective of the full experience. Reviews tend to be short or verbose or irrelevant. However, the questions and numeric rating scale present in the standard questionnaire presented by the website is designed to be reflective of the full experience and obtain the experience of the vast majority of patients rather than the few overly positive or decidedly negative incidents that are generally reported on-line. Medical providers tend to see 50-500 patients per month in the office. In addition to seeing patients in the clinic, surgeons perform 5 to 20 surgeries per month. The number of patients seen in the clinics and operated in surgical centers is not reflected anywhere on other websites. In other words, consumers would not be aware how many patients particular physician has been treating. More importantly, consumers are not aware of the fact how many patients with certain disease this medical provider had treated. This is crucial information for a decision making process when one has to choose a medical provider for a self-care.

A routine is scripted to track the total number of patients seen by the medical provider in their lifetime. The medical provider may place an estimate of how many patients doctor had seen up to date when starting with the website and then the routine takes over that count and continues automatically counting that number. The number can be placed into the medical provider's Patient Management Software. This is another bit of information posted on the medical provider's public profile page 70. Having this number displayed might be favorable from marketing point of view of physician.

The medical providers' knowledge base and interaction website is also configured on this web page 40 to at least one of 1) present a phone number to call or 2) present a hyperlink that causes a field to solicit from the user to take in a phone number to call the user, in order for users to have a way to connect in near real time with a first medical provider from the plurality of medical providers via a phone call.

FIGS. 5A and 5B illustrate embodiments of example search results pages 50, 52 showing the list of medical providers returned based on the search criteria selected by the user along with the data for the various criteria.

Ranking/Scoring of medical providers is based on the weighted order of the criteria that the user selected for the search. However, additional rankings such as best medical provider of the month can be solely based on patient survey results. Note, the grade/ranking based on patient reviews is a criteria that the user may select and weigh in for the search. The search is first narrowed on type of medical provider, (i.e. Physicians (M.D., D.O.) and potentially even specialty, Dentists (D.M.D), Chiropractors, Veterinary doctors, etc.

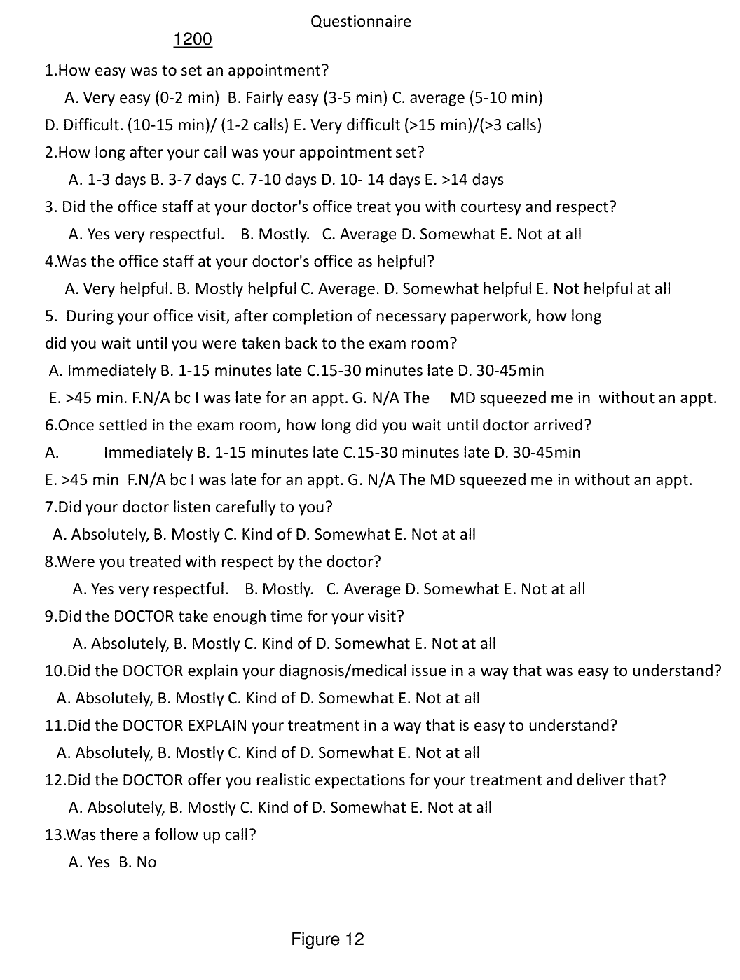

The website takes in and presents patients' reviews and also bases the medical provider's grade/rank at least in part on the patients' reviews. Others factors affecting grade/rank can be a combination of data with patient reviews and other factors. For example, the grade/ranking score in addition to the patient reviews may include 1) number of practicing years, 2) record of academic publishing (industry recognition is probably based on publishing record), 3) record of safety of medical care (the absence of medical board notations or lawsuits), 4) etc. The website may include separate searchable criteria headings to cover things such as a provider's educational and board credentials, number of practicing years, etc. Note, the website supplies the missing information important to patients, which is the quality of care and service provided by that particular physician based on the surveys. The quality of care and service provided by that particular physician is very important to the quality of the patient experience. This missing component of quality of care and service comes from at least the patient surveys. Fortunately, the medical providers' knowledge base and interaction website collects actual patient experience surveys. (see, for example, FIG. 12)

The survey presented by the website may take the above criteria into the questions that are sent out. The website collects actual patient survey data, which is verified to becoming from actual patients and actively collected by administrators of the website. The above data, which has been collected and verified by an independent third party, i.e. the website administrators, is then made freely available on the web for consumer perusal and decision making for a choice of provider: medical provider and hospital.

The medical providers' knowledge base and interaction website is structured to be an online platform which can help patients communicate his/her experience in the lay terms to another patient in organized and systematic manner. The website is structured to provide complete information about a medical provider including medical qualifications and actual customer service to aid in potential patient decision making. The physicians review website aims to be fair and impartial so that both parties patient and physician can publicly provide information on these topics. The physicians review website maintains the anonymity of the patient's identity from the public.

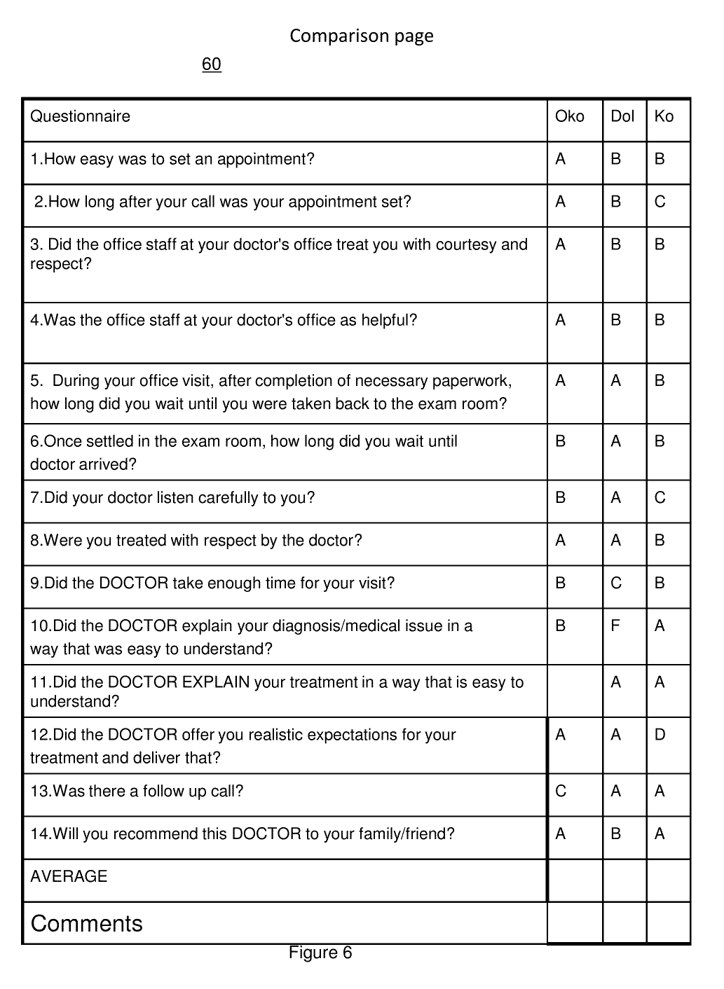

FIG. 6 illustrates an embodiment of a search results page 60 showing a comparison the medical providers and average patent survey results to be displayed to a user. The results for Dr. Oko, Dr. Dol., and Dr. Ko are displayed for 14 different criteria. A patient discussion platform in addition to the survey comments may be displayed.

Note, the medical providers' knowledge base and interaction website can be scripted to grade hospitals based on the average grade of all medical providers affiliated with that hospital. The staff doctors determine which hospital is the best. The filled out questionnaire on the average grades this medical provider has accumulated can be particularized to specific procedures/treatments or be an aggregate of all the reviews on the provider from all kinds of different procedures performed. Either way, links to additional populated averaged out survey questionnaire are also linked at the web site. For example, the filled out questionnaire on the average grades this medical provider to cover service to the patient's needs in a pre-surgical period can be linked to other completed questionnaires to cover service to the patient's needs in a post-surgical period.

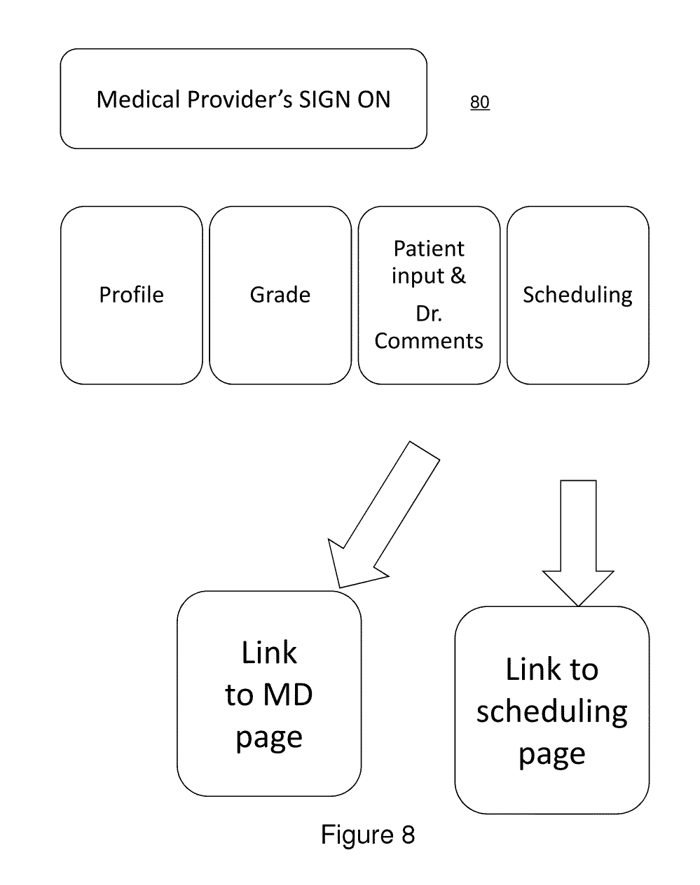

FIG. 8 illustrates an embodiment of a medical provider sign on web page 80. This web page is scripted to provide access for medical providers to link to things relevant for them. From the Home page, Clicking to MD/medical provider sign on tab brings the medical provider to medical provider sign on web page 80.

The medical providers' knowledge base and interaction website is scripted to allow the medical provider to have easy access online to their track record of grades and access them individually by parameter over a course of a time period if desired. In addition, a bar graph presentation of their current grades by percentage or against the average based on their chosen criteria, for instance, all medical providers, specialty, area, etc., is presented to the medical provider. (For example, see pages 7B-7F).

The web page 80 presents a tab for the search functionality to give an ability of the medical provider to compare himself/herself in the search criteria including 1) customer service rating of the medical provider, 2) overall ranking of the medical provider, 3) scoring in any particular category listed in the survey, and 4) the number of specific medical procedures performed and diseases treated, with one or more medical providers from the plurality, which the web page then displays the comparison data.

The web page 80 uses a histogram routine to give an ability to the medical provider to track their individual parameters and overall grade over time and compare himself/herself to their tracked history stored by a database cooperating with the website.

When the medical provider clicks on the grade hyperlink, a pop up window may appear and give the medical provider's rating breakdown in each category of the survey.

The medical provider in this context may extend to an administrator for the medical provider's office as well as hospital administrators to allow them as well the provider themselves to compare an individual medical provider to any individual physician or within his/her own group of physicians or with physicians within any given region, or specialties, or other parameters in the search criteria within the system.

The web page 80 presents links and fields to allow the medical provider to do actions such as but not limited to:
Edit the public profile presented in FIGS. 7A and 7B;
Review ranking score, the more detailed report is given here, LIKE A TREND. medical providers will be able to review in detail in graph or tabular view the results of the survey in the span of time (1 mo, 3 mo, 6 mo, 12 mo) similar to financial stock analysis;
MEDICAL PROVIDER CAN ACCESS the whole questionnaire and review statistics there, each question in detail;
Make some conclusions, or can ask our services for interpreting results in detail.
Patient's comments can be viewed under this icon and the making of medical provider rebuttal comments.
Whether the physician provides mobile care for in-house house calls.
This page 80 may also have a space for ecommerce: ability to enter credit card or bank information in order to pay for the services.

A scripted notice routine for the website is configured to collect and provide information such as the medical provider is sent emails, text messages, or other communications periodically, weekly or biweekly or monthly as desired, that give an overview of the results of patient reviews.

A scripted notice routine for the website is configured to collect and provide patient reviews. A routine keeps track that a medical provider will be given time to rebut negative comments, such as ten business days, before the routine publishes the negative comments. The medical provider is given time to rebut negative comments before those comments post on the web page. The medical provider is given a period of time after a patient review comes in to look over content including scores in the patient review and post a rebuttal comment before the patient review is posted on-line. The content analyzing routine reviews content from the patient review and when the content analyzing routine detects 1) the negative comments 2) low scores, and any combination of the two, the content analyzing routine initiates any of 1) an e-mail, 2) a text message or 3) similar message to be sent to the treating medical provider notifying that medical provider of the negative patient review. The medical provider's rebuttal comments may be posted in a manner visually highlighting the rebuttal comments from the negative comments. The routine may also post a set of replies thanking patients for their positive comments in an automated fashion.

Another verifiable feature the website offers is a benefit to the medical providers using the website. One manner in which the website tracks the site's advertising benefits for the medical provider is to track how many times a searching physician shows up in a search results page from the website's search feature or other result displaying the medical providers name. This will confer an actual measured amount of the site's ability to produce viewership and exposure for the physician. The website then tracks the number of times the physician's individual page is chosen, thereby allowing a physician the opportunity to see his/her progress on being selected when compared to other physician. This could and should lead to improvements of the MD's interaction pages with the patients. Using these tracking results the website then also emails these results to prospective physicians to show merits of this website.

FIGS. 7A and 7B illustrate embodiments of the medical providers published profile page 70 to the public on the website. The medical providers' knowledge base and interaction website is scripted to offer an interactive web based forum between the provider and his/her patients, via blogs, patient comments and doctor's positive or negative rebuttals to those patient comments, videos, etc. on his/her profile page 70. The medical provider also has the ability to rebuttal poor reviews or just plain comment on reviews on the multiple pages in which the survey data is presented to the public. The medical providers published profile page 70 provides detailed information about the provider such as their office hours, medical credentials, hospital affiliations, languages they speak, and more. The providers can personalize their profile listing with a description of their services, photos and videos of their practice, and downloadable forms for new patients. The medical providers published profile page allows interaction with patients in general through the blog, suggested reading, etc.

The medical providers profile published page 70 to the public has fields and tabs for information such as:
The Name of the provider; MD/DO Title; Photo of provider, and Photos of their office; Age; years practicing; statement; Generic biographical data of providers: Resume and/or CV 1; Contact info for each registered medical provider, directions to their office; Link to personal/office webpage; Map of office (in conjunction with a link to a Google-type map/direction); Specialty/subspecialty; Hospital affiliation=>link to the hospital;
Clinical interests; Grade/ranking of the provider; Insurance plans accepted;
link to a blog. The space for a blog can be provided by the web site.
also link to what medical provider is reading now.
a list of memberships the medical provider is a member of (professional medical societies), for instance: American Society of Plastic Surgeons with a corresponding link to that society website.
a list of CME courses completed by a medical provider (CME is continuing medical Education). Such courses provide up to date information to medical providers about new treatment options for certain diseases or teach medical providers certain new medical/surgical techniques
link to what the medical provider recommends patients to read, such as certain articles. This way the medical providers' knowledge base and interaction website is scripted to can get endorsements from leading medical journals.
The idea is that patients can follow their interesting physicians. The physicians embracing a social networking aspect will likely see a more following. Assumptions is that more and more young physicians start to practice, they will tend to be more social oriented to their patients and be open to share information about their practice and style of communication. The page allows the medical provider to continue “tell their story” via constant connection with patient population.
trend of number of procedures in the graph. Similar to a bill from energy company

This may be premium information for patients: The medical providers' knowledge base and interaction website is scripted to request procedures from surgeons to count and list the number of Surgical Procedures done by surgeons. A counter routine for the website is configured to collect and provide a number of specific procedures done by a provider. Record keeping for the number of times the physician perform each procedure (a counter tracks the number based on codes inputted at the start of the survey form process). Likewise, a counter tracks the number of times the provider has treated specific diseases.
The TOTAL NUMBER AND NUMBER BY CERTAIN PROCEDURE link may present a pop up window with medical procedures and/or diseases treated such as:
Total: 1,000
Appendectomies: 160
Cholecystectomies: 300
And so on.

The above information is crucial for decision making process for patients in order to distinguish medical providers. Medical providers of the same specialty subspecialize on certain procedures. For example: Among Orthopedic surgeons, they all can do pretty much all common orthopedic procedures. However, medical providers specializing on shoulders will definitely perform more shoulder procedures. They would still perform hip procedures but to a lesser degree. Having an access to that kind of information is very important.

Thus, a software routine, hardware device, or combination of the two keeps track of 1) a total number of specific medical procedures done by each medical provider in the plurality of medical providers, 2) a number of specific medical procedures done by each medical provider per set period of time such as per month, per quarter, per year, etc. 3) a total number of specific diseases treated by each medical provider, 4) a number of specific diseases each medical provider has treated per set period of time, and 5) any combination of these. The specific medical procedures and the specific diseases treated are searchable criteria in a search routine implemented on the website as well as displayed information on one or more webpages regarding each medical provider in the plurality of medical providers.

Another premium feature is information for medical providers. Every doctor has a specialty or niche service. The website will help elucidate/reveal specialties or special procedures performed by the medical provider and the number of those procedures to date in the manner which other companies have not done.
For Surgeons: The medical providers knowledge base and interaction website is scripted to keep track of the number and the type of procedures they have done up to date, (this can begin from the time they sign up with the web site). The medical providers' knowledge base and interaction website can be scripted to indicate the average number of procedures the surgeon should perform per year. So that consumers can determine whether the number they see is the appropriate number given doctors years of practice.

Similarly for Internal Medicine doctors, the medical providers knowledge base and interaction website is scripted to keep track of:
Number of patients with for example:
Diabetes Mellitus 500
Hypertension 400

and so on.

This could be a separate frame that can look like a table of all diseases with a number of treated patients with such disease. The web site attempts to get a precise number of diseases treated by a doctor or the number of specific procedure done by a surgeon by having that information supplied when the survey information is being supplied by the doctor's office. However, the count may begin from the date when the medical provider goes live with the site. At the same time doctors can come up with an approximate number of performed procedures prior to joining the website. Then the medical providers' knowledge base and interaction website is scripted to add the newly occurring procedures to their total count.

Patients viewing the medical provider's page will have an opportunity to click on the LIKE BUTTON (or similar button) in order to add this medical provider to their favorite medical providers list.

Also, Web Scheduling from a link on the doctor's page may occur in real time, with a link to FIG. 9, the calendar page. For all actions with the medical provider and the medical provider's office are matched to a database that maintains their login security passwords to ensure that the medical provider is actually providing this information.

FIG. 9 illustrates an embodiment of an online scheduling calendar presented by a web page 90 to make an appointment. In FIG. 9, the medical provider's office can manually enter available times open. Alternatively, an application program interface is presented by the website to interface with common scheduling programs used by most medical providers, and is modifiable to interface even with custom scheduling programs. The routine allows the patient to schedule an online appointment with the medical provider on the available slots on the calendar, which is captured and sent through the Application Program Interface to the providers scheduling program or sends both an e-mail to the provider and logs a notification to be presented to the medical providers when they next log into the website.

Returning back to a list of doctors, FIGS. 5A and 5B illustrate an embodiment of a search results page 50, 52 showing the medical providers with their earliest available times ordered as a high ranking criteria in the search query.

The appointments with earliest available times will be displayed in the table as one of the columns. The hours are clickable for further registration. Clicking on appointment time will bring to a confirmation page. This step can be streamlined in a similar way as “one click” purchase in Amazon.com.

The web page 90 cooperates with an interface mechanism, such as a doctor's office inputting available dates or telling the website certain times each week are available, to allow one or more of the medical providers to offer patients an ability to schedule appointments online via the website. A scheduling routine guides a user to be able to choose an earliest available time vacant for booking the scheduled appointment with one or more of the medical providers from the plurality of medical providers.

FIG. 11 illustrates an embodiment of a medical provider's office data input page 1100. In order to prepare a printed slip with a code for a patient, the DOCTOR'S office must enter the following information to link the patient to this limited biographical info:
Date of Visit; Age of patient; First name; Procedure; Type of visit: pre-Op or Post-OP; Hospital name, where procedure was done; Patient's phone; and other similar information.

In other words, at the end of patient's visit, the office staff will input the above information into the website, the website has a program that will generate a unique security code linking the visit to the physician, patient, visit date and print this code on a sheet of paper with a questionnaire applicable for the type of visit. This form will also have a pre-paid bar code/stamp that will enable the patient to simply and easily fill out the questionnaire and send it to the website's processing facility via mail.

Note, hospitals and insurance companies may also a have a page similar to the medical provider's office data input page to trigger the features and benefits of this website.

The medical providers' knowledge base and interaction website is scripted to maintain integrity by starting/creating the review process at the medical provider's office. This allows for patients creating reviews that are verifiable that have been seen by the medical provider. The website is then scripted to provide accumulated patient reviews from patients of each medical provider who through a verification mechanism have indeed been seen and serviced by that medical provider as controlled by a survey mechanism. The survey mechanism includes both 1) an assignment of a unique code to a survey given to the patient to complete as well as 2) a method of collecting the survey results from the patient, which combine as the verification mechanism to ensure that the patient reviews are coming from patients who have indeed been seen and serviced by that medical provider.

The medical providers' knowledge base and interaction website is scripted to have the patients' surgery or disease coding and conditions inputted directly by the medical provider's office itself, which allows the scripted routines to count the number of procedures performed by the medical provider, which will be categorized as 3rd party verifiable by the website's company.

The algorithms in the website are scripted to make many nexuses based on the collected information. For example, by tracking the count the number of procedures on this specific task performed by the medical provider, the medical providers' knowledge base and interaction website is scripted to allow the doctor to be found/searched by his expertise and keywords such as disease names. In other words patients have the ability to find a doctor not only by the doctor practices in that general field but also how many patients with similar disease the medical provider has seen before, correlated with grade.

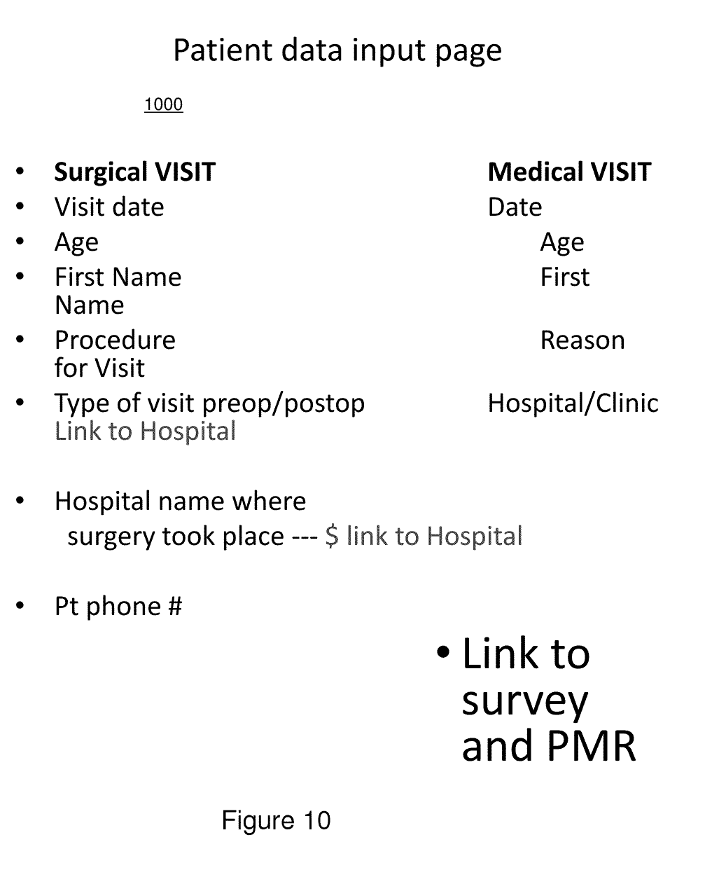

FIG. 10 illustrates an embodiment of a patient data input web page 1000. The patient may input data that is later linked to populate information in the survey questionnaire and populates information in their Personal Medical Record tracked in their personal account on the website. The website caters to non-registered user (standard site visitors). However, the website also provides additional benefits to registered users by storing this information and not making the user type the information in again.

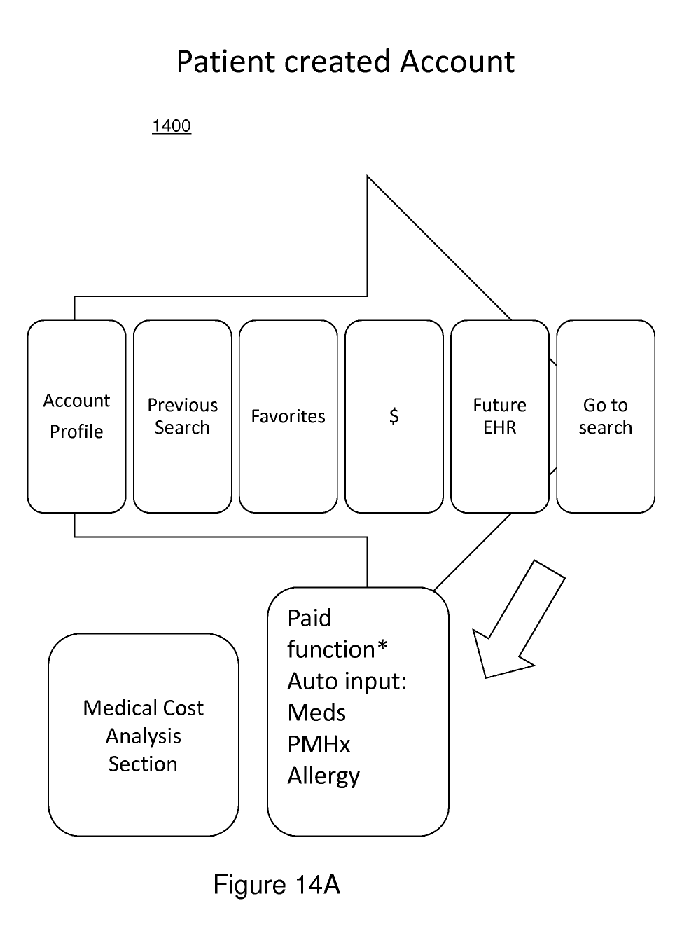

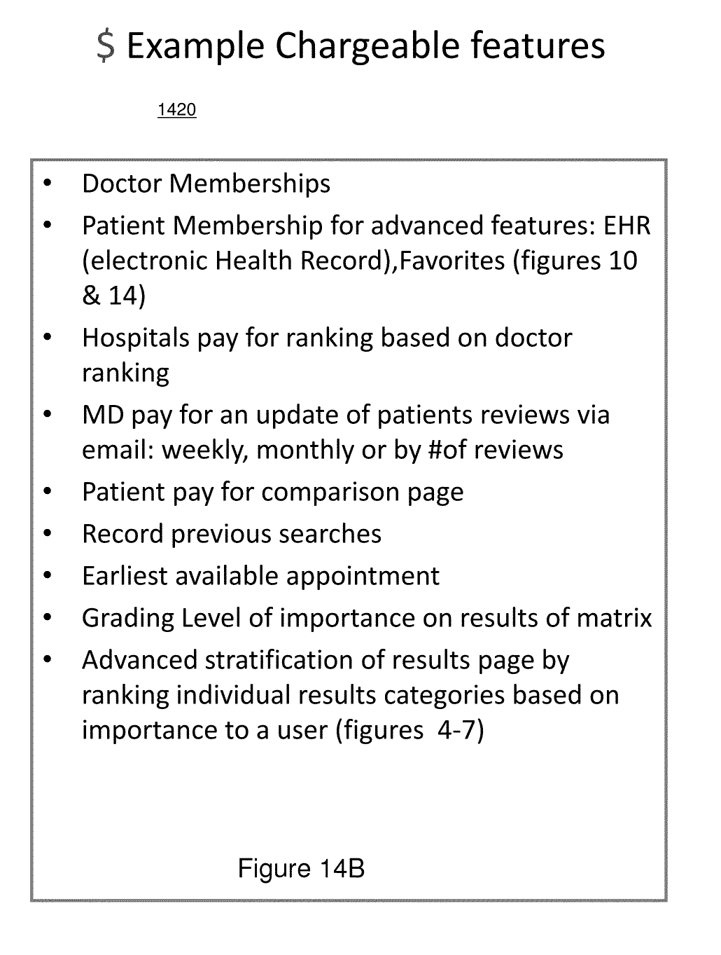

FIGS. 10 and 14A illustrate embodiments for a patient's account page 1400 and a patent input page 1000 that are linked. Another important function of the medical providers' knowledge base and interaction website is to be is an easily accessible CLOUD space for patient's personal medical history, medications, allergies, surgical history and list of all the doctors patient had been seen in different Healthcare organizations.

The web pages 1400, 1000 have an adapter to Patient Management Software that allows the website to collect a patients' data on an automated basis and then store the patients' data in a cooperating database. This adapter and its collected patient data will be used in the process of patient verification process.

As discussed, the website provides medical provider search functions, —Physician search, —Dentist search, —Chiropractor search, —Veterinary doctor search, etc. When patients search for a doctor indicating specific disease, this disease can be, at the patient's option, included in their profile as a Current Medical History. The profile is a part of Personal Medical Record (PMR).

The personal (patient's) health information stored in the PMR is different from some other Electronic Health Records. The PMR can include list of allergies, list of surgeries, list of medications, list of all doctors patient had seen in the past, which is useful when filling in certain documents or for medical providers. This PMR contains the information inputted into the system automatically when the user does the search and each time a survey is filled out. The user may also manually add or delete information from their PMR. The user may send their PMR to a medical provider to supply the medical provider with a more complete medical history.

A comparison wizard is scripted to refer to a database and provide estimated cost comparison to a consumer for a procedure and cross comparisons of costs for a procedure between existing providers. The comparison wizard references the database to personalize cost and quality information for that user's needs and insurance, which is not now publicly available. Rather than showing the average cost of a service, such as seeing a doctor or getting a cholesterol test, the comparison wizard references the database to show the users what their personalized cost for that service would be, based on where they are in their plan today. For example, the user's cost for a particular health care service will be a function of what the negotiated rate is, what the user's employer or insurer pays for that health care service, and what the anticipated out of pocket cost is to the user after health insurance is factored in. The comparison wizard shows all of that to the user in a very consumer friendly way.

Thus, a web page 1400 is scripted to provide a medical costs analysis section. In the medical costs analysis section, the webpage presents fields to solicit the following information and the user enters the information including a State where a medical procedure is to be performed, an Insurance plan of the user, a hospital where the medical procedure is to be performed, a name of the medical provider, and other similar information or grabs this information from their patient account and prepopulates the known information; and then, based on this information a cost routine will be able to provide prognostic data of an anticipated amount of medical costs to the user for that medical procedure.

Once the medical provider sees patients, then they are approached by the website's third party service based on the various on-line, e-mail, and/or call center survey taking mechanisms. The medical providers' knowledge base and interaction website is scripted to survey the majority of patients for their experience with doctor and analyze the results. The results are translated into a ranking that is attached to and tracked for every provider. The ranking is a searchable item.

The medical providers' knowledge base and interaction website is scripted to capture the majority of patients seen for medical or surgical care. The data is then gathered in by the website in an integrated manner, stored in a database, and then presented for a review for new patients.

Similarly, medical providers having an access to this data to be able to make improvements to their way of providing care. Patients will know that and will appreciate those doctors.

FIG. 12 illustrates an embodiment of an example questionnaire page 1200 presented to a user/patient after the security code has been validated. The example questionnaire has a limited set, such as 8-15, sentence questions to best reflect patients' experience during appointment with the doctor. These questions are different from the conventional questionnaire to assess patient experience. A conventional questionnaire is geared for hospital improvement. The website's questionnaire simulates a pass of information from one patient to a prospective patient that would happen in casual atmosphere. The survey questions are geared so that the answers will help explain the patients' experience with a specific doctor. A weighting algorithm mathematically analyzes the answers and a ranking digit will be assigned to that doctor. To avoid grouping of many doctors in one area of spectrum, each answer will be given a different degree of importance. Since this manner of data collection will offer many reviews, the large amount of feedback allows doctor to make informed and educated decisions on where substantial improvement on their part is needed.

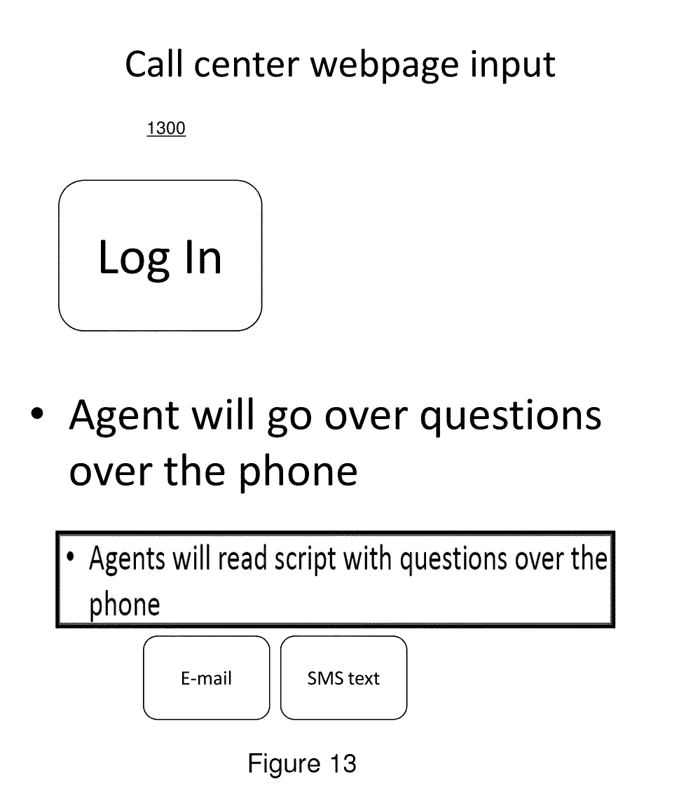

At the end of an appointment, each patient receives a paper slip with applicable questionnaire and a special code. A patient can elect to fill out the paper questionnaire and send in form which already include prepaid postage. Alternatively, a patient can complete a survey online via using above code which is entered on our website in special frame. When the website is supplied with the email address of the patient, then the website scripts will send a patient email with a secure link to our website where they can complete a survey. If patients do not have an email address or patients fail to perform the above task, the website will generate a notice to physically mail them a hard copy of questionnaire with prepaid postage. If neither is performed within, for example, 2 weeks, the systems algorithm will place them into the call center pool. The website may also email once a week for 3 weeks (see FIG. 13 for the e-mail routine). At which point, the patients will be called to complete the survey. In addition, the patients who fail to complete survey in timely manner, the reminders will be e-mailed (1 week, 2 week, and lastly 3 week period) and at the end of one-month post appointment, then the call center representative will place a call to complete survey over the phone. In addition to once a week emailing, the website can send a SMS text to the patient's mobile phone or to a landline (via text-to-Landline system) with a short message which will contain the link to the website for the surveying, also once a week (see FIG. 13 for the SMS text routine).

Thus, multiple methods, an in office request, a hard copy survey received in the office to mail in, on-line availability, e-mails, and eventually phone calls will be made in an effort to capture the majority of patients and their experience in every office, in order to gather post appointment opinion and review it in systematic way. The website attempts to gather a statistically significant sample size of patient ratings and store them in the database, which the amount impacts the quality of information available to consumers, so consumers get an accurate view of the medical provider. Internet users rating medical providers on websites tend to have potential biases. By collecting data through multiple mediums at the office, over the phone, and on-line, the website attempts to balance out those biases to achieve an accurate reflection of the provider. The medical providers' knowledge base and interaction website is scripted to actively and not intrusively seek the patients input, via electronic completion of the questionnaire (see FIG. 12) or via call center agent (see FIG. 13). Next, the medical providers knowledge base and interaction website is scripted to analyze it and create unifying ranking of every provider. Survey responses will provide abundant amount of objective information about the provider. Patients will be able to compare the number of procedures performed and the number of specific conditions treated. The latter information presents to be valuable information for consumers when comparing several medical providers.

From the perspective of the physicians, such a resource gives them an opportunity to stand out among colleagues. The website and call center attempt to contact every patient post appointment, which conveys and represents the doctor's care about the patient and dedication to continuous improvement.

The method of collecting the survey results from the patient for the survey mechanism can include patients can enter their randomly assigned code that the patient received in medical provider's office after the appointment into a webpage presented by the website in order to be brought to a separate webpage to complete a review of their last office visit. The website is configured to assign a set of unique codes to the medical provider's office and store those assigned codes associated with a particular medical provider and then uses this stored information to verify that merely a select qualified group of people being the actual patients of the medical provider are providing the patient review information.

The patient opinion data collected in a survey may be on, for example:
Office Staff: This is a measurement of how well the patient is treated before they see the doctor. Base the patient's opinion on their experience making an appointment, how the patient is greeted for an office visit, and how well the office staff meets the patient's needs as a patient.
Office Setting This is a measurement of the appearance and cleanness, of a doctor's facilities.
Wait Time This represents how long the patient has to wait to get an appointment and how long the patient has to wait in the doctor's office.
Medical Knowledge The patient's opinion of how knowledgeable the doctor is in his or her field.
Bedside Manner The attitude and conduct of a physician in the presence of a patient.
Patient Confidence The patient's overall level of confidence with the doctor's ability to treat you. If the patient would recommend this doctor to a family member or close friend.
Patient Satisfaction This is the patient's overall level of Satisfaction with the Doctor and his or her Treatment.

The example questions for an office visit can be as follows:
1. How easy was to set an appointment?
A. Very easy (0-2 min); B. Fairly easy (3-5 min); C. average (5-10 min)
D. Difficult. (10-15 min)/(1-2 calls); E. Very difficult (>15 min)/(>3 calls)
2. How long after your call was your appointment set?
A. 1-3 days; B. 3-7 days; C. 7-10 days; D. 10-14 days; E. >14 days
3. Did the office staff at your doctor's office treat you with courtesy and respect?
A. Yes very respectful; B. Mostly; C. Average; D. Somewhat; E. Not at all
4. Was the office staff at your doctor's office as helpful?
A. Very helpful; B. Mostly helpful; C. Average; D. Somewhat helpful
E. Not helpful at all
5. During your office visit, after completion of necessary paperwork, how long did you wait until you were taken back to the exam room?
A. Immediately; B. 1-15 minutes late; C. 15-30 minutes late;
D. 30-45 min E. >45 min; F. N/A because I was late for an appointment
G. N/A because doctor squeezed me in without an appointment
6. Once settled in the exam room, how long did you wait until doctor arrived?
A. Immediately; B. 1-15 minutes late; C. 15-30 minutes late; D. 30-45 min E. >45 min; F. N/A because I was late for an appointment
G. N/A because doctor squeezed me in without an appointment
7. Did your doctor listen carefully to you?
A. Absolutely; B. Mostly; C. Kind of; D. Somewhat; E. Not at all
8. Were you treated with respect by the doctor?
A. Yes very respectful; B. Mostly; C. Average; D. Somewhat; E. Not at all
9. Did the DOCTOR take enough time for your visit?
A. Absolutely; B. Mostly; C. Kind of; D. Somewhat; E. Not at all
10. Did the DOCTOR explain your diagnosis/medical issue in a way that was easy to understand?
A. Absolutely; B. Mostly; C. Kind of; D. Somewhat; E. Not at all
11. Did the DOCTOR EXPLAIN your treatment in a way that is easy to understand?
A. Absolutely; B. Mostly; C. Kind of; D. Somewhat; E. Not at all
12. Did the DOCTOR offer you realistic expectations for your treatment and deliver that?
A. Absolutely; B. Mostly; C. Kind of; D. Somewhat; E. Not at all
13. Was there a follow up call?
A. Yes; B. No
14. Will you recommend this DOCTOR to your family/friend?
A. Yes; B. No
15. Comments:
Question #16. Overall, how would you describe your experience during this visit.
A. Positive; B. Neutral; C Negative;

Similar qualitative example questions are set up for hospital procedures and appointments such as:

1. Were the results of surgery explained/forecasted or promised?
2. Were RISKS/BENEFITS of surgery explained?
3. Were outcomes end up being as expected/promised?
4. Were outcomes explained by SURGEON?
5. Was there a delay in your surgery?
6. Was hospital staff respectful?
7. Was the office respectful of your time?
8. Was the pre-operation process smooth?
9. Did the OR staff explain the process of surgery?
10. Did surgery office contact you after surgery to see how are you doing?
11. Satisfaction with the Post op visit?

The qualitative example survey questions can be tailored to be more on point for various specialties such as for example Pediatrics. However, every provider in this specialty is evaluated with the same set of questions, for example:

1. low often did your DOCTOR explain things in a way that was easy to understand to you?
2. How often did your DOCTOR explain things in a way that was easy to understand to your child?
3. How often did you your pediatrician listen?
4. How often did your pediatrician give you clear instructions about what to do to take care of health problems or symptoms that were bothering your child?
5. How often did your pediatrician show respect for what you had to say?
6. How often did your pediatrician show respect for what your child had to say?
7. Did your pediatrician spend enough time with your child?

FIG. 13 illustrates an embodiment of a page 1300 presented to a call center. This is the page for call center log in and input the answers of the patients who did not complete the questionnaire. The agents will see a list of first names in a queue (list in the table view).

By clicking on the name, agent is brought to another page with a contact number and the list of questions, on the same page. The clicked name disappears from the master list. Other agents will not see that name. In case the patient did not answer the phone, the agent clicks on the button that states, no answer. The name of the patient returns to the CALL LIST.

When the website uses telephony software that will dial the number automatically once the name of the patient is clicked, and it will speed up the process of calling.

Agent calls, introduces herself/himself by saying that they call on behalf of the doctor who is very conscious about the patient's experience and aspires to improve the care a.s.a.p. after the comments are given by patients. The call and results are anonymous. As a call center agent reads questions and hears answers, the agent clicks on answers published on the website's webpage. An algorithm analyzes the answers and answers are contributed to a corresponding doctor data file.

The call will take 4-6 minutes. The agent thanks patient and hangs up.

The results of the questionnaire are queued up to the algorithm of the doctor. The ranking is affected almost right away but not in major way. We can decide on how many reviews at a time can affect ranking. For example, 10 completed reviews can move the score of the ranking.

FIG. 14A illustrates an embodiment of a patient's personal page 1400 allowing creation of a Patient Created Account.

The following tabs are displayed:
Patient Profile: This one can be linked to Personal Medical Profile
List of previous searches with names of the physicians (hyperlinked to corresponding webpages of those doctors)
Favorites=>this one and the list of previous searches can be under the same tab.
PREMIUM TAB
PERSONAL MEDICAL RECORD (PMR), not to confuse with Electronic Medical
Record the hospitals use:
Medical and surgical history: each disease is linkable to other resources, such as modern treatment options, dictionary or discussion forums
   List of Medications: if possible we can list a Pharmacy
   List of Allergies
      GO TO SEARCH

The medical providers' knowledge base and interaction website is scripted to have several pages aimed at giving the medical provider greater exposure as they will be seen on this website as opposed to other medical providers who have not yet participated or chose not to. For example, there is an award recognition on the home page for the best the medical providers by time (week, month or year) or by geography (city town, state, national, hospital), which are all based on patient review surveys with no arbitrary peer or other review influencing this exposure. The website is designed to give visibility to medical providers on the Internet with credibility verified by a third party.

This page 1400 also can be a ground for patients (registered patients) to post their medical problems (anonymously) so that member physicians can elect to offer their medical expertise. The doctor can reply to the message privately via our platform and patient will see a message in their inbox (on our platform). Patient will establish an appointment as a result of their discussion. In a way, this is a bidding process, where patients post themselves and doctors are choosing them to treat them.

A web page is set up to provide interactive patient education on medical matters.

In an embodiment, the architecture of the website and service can be viewed from two perspectives, 1) a consumer-centric and 2) a provider-centric approach.

### Consumer-Centric and Medical Provider-Centric Approach:

Consumer-Centric Approach:
1. The integrated system and its configured search engine will allow patients to make a Choice of the healthcare provider based on a number of criteria.
2. Healthcare provider's quality of care is ranked based on proprietary questionnaire filled in by the former patients via our proprietary system.
3. Once patients determine a physician they would like to see, the system will offer them to schedule an appointment on earliest available day or any other date.
4. One of the search criteria for a doctor is an input of a disease by a consumer. This disease will be automatically added to patient's personal medical record (PMR) which can be used as a personal health file consisting of medical history, surgical history, medications list, social history, list of all physicians with their addresses, list of patient's insurance companies.
5. Patients will be able to enter disease discussion forums offered on our platform. Every disease on patients record is linkable to a number of choices: evidence based treatment options (written in succinct manner), discussion forum.
6. Still in Personal Medical Record: Consumer will have Personal Medical Calendar for upcoming suggested prophylactic healthcare events based on the age: such us Annual checkups, Mammography, Pap smear, Colonoscopy, Dental exam, Dental Cleaning and so on.
7. For a fun part, the clock providing patients total years, days, and hours of life. In other words as well, patients:
1) will simply be able to access large volumes of raw data and refine their search based on experience based reviews of former patients.
2) items not limited to time, respect, cleanliness, professionalism, education and follow up
3) patients will be able to compare medical providers
4) patients will be able to review why medical providers received certain grades based off of finer detail of all parameters. To tailor to their specific needs or like and dislikes.
5) patients can choose their medical provider based off of the DZ or SX review then which medical provider has the grades they like.

Medical Provider-Centric Approach:
1. Doctors/medical providers will get reviews from 30-90% of their patients (compare to 0-3% currently, based on our observation).
2. Patients will get more attention from doctors/providers in post appointment time via interaction with us on behalf of the doctor. This should lead to increased business.
3. Doctors will be able to offer a personal webpage with richer and more useful content which is more than just educational and academic credentials.
4. Appointments will be offered via our platform.
5. Doctors will have an opportunity to place educational content on their webpage. The medical providers' knowledge base and interaction website is scripted to assist in making presentation to the level of professional grade.
6. Doctors will have their own back office portal with an access to survey data, full list of their patients

FIG. 14B illustrates a chart 1420 of some example PREMIUM SERVICES: Doctor Memberships
Patient Membership for advanced features: EHR (Personal Medical Record in a way a short version of Electronic Health Record),
Favorites (FIG. 14A)
Hospitals pay for ranking based on doctor ranking
MEDICAL PROVIDER pay for an update of patients reviews via email: weekly, monthly or by # of reviews
Patient pay for comparison page
Record previous searches
Earliest available appointment
Grading Level of importance on results of matrix
   Advanced stratification of results page by ranking individual results categories based on importance to a user (Figures PPP 4-7)

The website is scripted to provide additional functionality including:
1. An application that can be downloaded from the site for a mobile computing device allows functions such as: Business cards of medical providers might include QR (QR code will be provided by the website's systems and routines or the website will provide custom business cards for physicians with imprinted QR code), after scanning the QR code with smartphone, the webpage of doctor will open up (the webpage of the doctor on our website), the owner of that business card. The mobile page of the doctor is the webpage (mobile version) of the original doctor page on our website.
2. Award or a title based on best ranking, by hospital, area, state, weekly, monthly. The award can be called PREMIER DOCTOR, or PREMIER HOSPITAL, or PREMIER CLINIC
3. The Home page of the website lists the total number of hospitalized patients in given city by hospital. It can be compared to another large city (NYC, San Fran, LA, etc.).
4. Generic biographical data of providers: Resume or CV
5. Contact info: address; phone number, fax number; an Internet address of doctor's webpage.
6. A button with a phrase: “email to doctor” (the doctor's email is not revealed. When patient clicks on the button: the pop up frame appears with several fields to fill in by a patient: patient's email; patient's name; topic of email; and a field for a body of question; lastly send button), as message is sent the pop up frame disappears.
7. Separate button for the following function: if patient were to desire to have the contact info of the doctor to be texted to patients phone as a reminder, the patient can enter their mobile number.
Alternatively, the email address can be entered and doctor's info will be emailed.
8. Photo of provider
9. Photos of office
10. Map of office (in conjunction with Google Map or Microsoft Bing Map, etc.)
11. Specialty/Subspecialty
12. Online scheduling
13. Estimated cost comparison to a consumer for a procedure and cross comparisons of costs for a procedure between existing providers.

### Computing System

FIG. 15 illustrates a block diagram of an example computing system that may use an embodiment of one or more of the software applications discussed herein. The computing system environment 800 is only one example of a suitable computing environment, such as a client device, and is not intended to suggest any limitation as to the scope of use or functionality of the design. Neither should the computing environment 800 be interpreted as having any dependency or requirement relating to any one or combination of components illustrated in the exemplary operating environment 800.

As discussed, the computing system may be a client mobile computing system. The system includes a processor, a memory, a built in battery to power the mobile computing device, a built-in video camera and display screen for the mobile computing device, and built-in Wi-Fi circuitry to wirelessly communicate with a server computer connected to network. In regards of viewing ability of this website: this website has code to be adapted to be viewed on tablets and mobile phones, such as individual downloadable applications in data stores that are designed to interface with the website, as well as by a desktop computer with a browser.

The design is operational with numerous other general purpose or special purpose computing system environments or configurations. Examples of well-known computing systems, environments, and/or configurations that may be suitable for use with the design include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The design may be described in the general context of computing device executable instructions, such as program modules, being executed by a computer. Generally, program modules include routines, programs, objects, components, data structures, etc. that performs particular tasks or implement particular abstract data types. Those skilled in the art can implement the description and/or figures herein as computer-executable instructions, which can be embodied on any form of computing machine readable media discussed below.

The design may also be practiced in distributed computing environments where tasks are performed by remote processing devices that are linked through a communications network. In a distributed computing environment, program modules may be located in both local and remote computer storage media including memory storage devices.

With reference to FIG. 15, an exemplary computing type system for implementing the design includes a general-purpose computing device in the form of a computer 810. Components of computer 810 may include, but are not limited to, a processing unit 820 having one or more processing cores, a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) locale bus, and Peripheral Component Interconnect (PCI) bus.

Computer 810 typically includes a variety of computing machine-readable media. Computing machine-readable media can be any available media that can be accessed by computer 810 and includes both volatile and nonvolatile media, removable and non-removable media. By way of example, and not limitation, computing machine readable mediums uses include storage of information, such as computer readable instructions, data structures, program modules or other data. Computer storage mediums include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible medium which can be used to store the desired information and which can be accessed by computer 800. Communication media typically embodies computer readable instructions, data structures, program modules, or other transport mechanism and includes any information delivery media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 15 illustrates operating system 834, application programs 835, other program modules 836, and program data 837.

The computer 810 may also include other removable/non-removable volatile/nonvolatile computer storage media. By way of example only, FIG. 15 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, USB drives and devices, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

The drives and their associated computer storage media discussed above and illustrated in FIG. 15, provide storage of computer readable instructions, data structures, program modules and other data for the computer 810. In FIG. 15, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A monitor 891 or other type of display screen device is also connected to the system bus 821 via an interface, such as a video interface 890. In addition to the monitor, computers may also include other peripheral output devices such as speakers 897 and printer 896, which may be connected through an output peripheral interface 890.

The computer 810 may operate in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 15 include a local area network (LAN) 871 and a wide area network (WAN) 873, but may also include other networks. Such networking environments are commonplace in offices, enterprise-wide computer networks, intranets and the Internet. A browser application may be resident on the computing device and stored in the memory.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user-input interface 860, or other appropriate mechanism. In a networked environment, program modules depicted relative to the computer 810, or portions thereof, may be stored in the remote memory storage device. By way of example, and not limitation, FIG. 1 illustrates remote application programs 885 as residing on remote computer 880. It will be appreciated that the network connections shown are exemplary and other means of establishing a communications link between the computers may be used.

It should be noted that the present design could be carried out on a computing system including laptops, smart phones, etc. such as that described with respect to FIG. 15. However, the present design can be carried out on a server, a computer devoted to message handling, or on a distributed system in which different portions of the present design are carried out on different parts of the distributed computing system.

Another device that may be coupled to bus 811 is a power supply such as a battery and Alternating Current adapter circuit. As discussed above, the DC power supply may be a battery, a fuel cell, or similar DC power source that needs to be recharged on a periodic basis. The wireless communication module 872 may employ a Wireless Application Protocol to establish a wireless communication channel. The wireless communication module 872 may implement a wireless networking standard such as Institute of Electrical and Electronics Engineers (IEEE) 802.11 standard, IEEE std. 802.11-1999, published by IEEE in 1999.

While other systems may use, in an independent manner, various components that may be used in the design, a comprehensive, integrated system that addresses the multiple advertising system points of vulnerability described herein does not exist. As described, examples of mobile computing devices may be a laptop computer, a cell phone, a personal digital assistant, or other similar device with on board processing power and wireless communications ability that is powered by a Direct Current (DC) power source that supplies DC voltage to the mobile device and that is solely within the mobile computing device and needs to be recharged on a periodic basis, such as a fuel cell or a battery.

### Network Environment

FIG. 16 illustrates a diagram of a network environment in which the techniques described may be applied. The network environment 200 has a network 202 that connects server computing systems 204-1 through 204-n, and at least one or more client computing systems 200-1. As shown, there may be many server computing systems 204-1 through 204-n and many client computing systems 200-1 through 200-n connected to each other via a network 220, which may be, for example, the Internet. Note, that alternatively the network 220 might be or include one or more of: an optical network, the Internet, a Local Area Network (LAN), Wide Area Network (WAN), satellite link, fiber network, cable network, or a combination of these and/or others. It is to be further appreciated that the use of the terms client computing system and server computing system is for clarity in specifying who generally initiates a communication (the client computing system) and who responds (the server computing system). No hierarchy is implied unless explicitly stated. Both functions may be in a single communicating device, in which case the client-server and server-client relationship may be viewed as peer-to-peer. Thus, if two systems such as the client computing system 200-1 and the server computing system 204-1 can both initiate and respond to communications, their communication may be viewed as peer-to-peer. Likewise, communications between the client computing systems 204-1 and 204-2, and the server computing systems 200-1 and 200-2 may be viewed as peer-to-peer if each such communicating device is capable of initiation and response to communication. One or more of the server computing systems 204-1 to 204-n may be associated with a database such as, for example, the databases 206-1 to 206-n. A firewall such as, for example, the firewall may be established between a client computing system 200-3 and the network 220 to protect data integrity on the client computing system 200-3.

FIG. 16 also illustrates a block diagram of an embodiment of a server computing system to display information, such as a web page, etc. The application, such as a social network application (e.g., Twitter), when executed on the server computing system 204-1, causes the server computing system 204-1 to display windows and user interface screens on a portion of a media space, such as a web page. A user via a browser from the client computing system 200-1 may interact with the web page, and then supply input to the query/fields and/or service presented by a user interface of the application. The web page may be served by a web server computing system 204-1 on any Hypertext Markup Language (HTML) or Wireless Access Protocol (WAP) enabled client computing system 200-1 or any equivalent thereof. For example, the client mobile computing system 200-1 may be a smart phone, a touch pad, a laptop, a netbook, etc. The client computing system 200-1 may host a browser to interact with the server computing system 204-1. Each application, widget, plug-in, etc. has a code scripted to perform the functions that the software component is coded to carry out such as presenting fields and icons to take details of desired information. Algorithms and engines within the server computing system 204-1 take the information from the presenting fields and icons and put that information into an appropriate storage medium such as a database. The applications may be hosted on the server computing system 204-1 and served to the browser of the client computing system 200-1. The applications then serve pages that allow entry of details and further pages that allow entry of more details.

Any application and other scripted code components may be stored on a non-transitory computing machine-readable medium which, when executed on the server causes the server to perform those functions. In an embodiment, the software used to facilitate the functions and processes described herein can be embodied onto a computing machine-readable medium such as computer readable medium. The applications, modules and other similar logical sequences may be implemented as software code, hardware circuits, and any combination of the two, and portions of the downloadable reminder application scripted in software code are stored in a non-transitory computing device readable medium in an executable format by a processing component. In an embodiment, the hardware logic consists of electronic circuits that follow the rules of Boolean Logic, software that contain patterns of instructions, or any combination of both.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. These algorithms may be written in a number of different software programming languages such as C, C++, Java, HTML, or other similar languages.

It should be borne in mind, however, that all of these and similar terms are to be associated with the appropriate physical quantities and are merely convenient labels applied to these quantities. Unless specifically stated otherwise as apparent from the above discussions, it is appreciated that throughout the description, discussions utilizing terms such as “processing” or “computing” or “calculating” or “determining” or “displaying” or the like, refer to the action and processes of a computing system, or similar electronic computing device, that manipulates and transforms data represented as physical (electronic) quantities within the computing system's registers and memories into other data similarly represented as physical quantities within the computing system memories or registers, or other such information storage, transmission or display devices.

The present concept also relates to apparatus for performing the operations herein. This apparatus may be specially constructed for the required purposes, or it may comprise a general purpose computer selectively activated or reconfigured by a computer program stored in the computer such that it accomplishes one or more purposes.

Although embodiments of this invention have been fully described with reference to the accompanying drawings, it is to be noted that various changes and modifications will become apparent to those skilled in the art. Such changes and modifications are to be understood as being included within the scope of embodiments of this invention as defined by the appended claims. The invention is to be understood as not limited by the specific embodiments described herein, but only by scope of the appended claims.

1. An apparatus, comprising:
a website consisting of one or more webpages hosted on a server configured to convey a medical provider's knowledge base and interaction website;
where the website is configured to maintain and display information regarding a plurality of medical providers and a user of the website may search the knowledge base regarding the plurality of medical providers;
a counter configured to keep track of 1) a total number of specific medical procedures done by first medical provider in the plurality of medical providers, 2) a number of specific medical procedures done by the first medical provider per set period of time, 3) a total number of specific diseases treated by the first medical provider, 4) a number of specific diseases the first medical provider has treated per set period of time, and 5) any combination of these, and where the specific medical procedures and the specific diseases treated are searchable criteria in a search routine implemented on the website as well as displayed information on one or more web pages regarding each medical provider in the plurality of medical providers, where the website and its functionality may be implemented with coded software, hardware circuits, and any combination of both, and where any portions of the website and its functionality implemented in coded software are stored in a non-transitory computer readable medium in format executable by a processing component.

2. The apparatus of claim 1, where the medical providers' knowledge base and interaction website is scripted to provide a best match between a potential patient's needs, including at least 1) customer service rating of the medical provider, 2) ability for home visits by the medical provider, 3) insurance accepted by the medical provider, 4) overall ranking of the medical provider, 5) medical skills of the medical provider indicated by the number of specific medical procedures performed and diseases treated, 6) gender of the medical provider, 7) online appointment availability to see the medical provider, 8) years of practice of the medical provider, 9) religion of the medical provider, 10) human languages spoken at the medical provider's facility, and 11) any combination of at least three of these criteria, to one or more medical provider's from the plurality who hold the skills required to address the user's problem.

3. The apparatus of claim 1, where the medical providers' knowledge base and interaction website is scripted to provide patient reviews of a medical provider that are displayed on one or more web pages, where the medical provider is given time to rebut negative comments before those comments post on the web page, where the medical provider is given a period of time after a patient review comes in to look over content including scores in the patient review and post a rebuttal comment before the patient review is posted on-line, and where a content analyzing routine reviews content from the patient review and when the content analyzing routine detects 1) the negative comments 2) low scores, and any combination of the two, the content analyzing routine initiates any of an e-mail or a text message to be sent to the treating medical provider notifying that medical provider of the negative patient review.

4. The apparatus of claim 1, where the medical providers' knowledge base and interaction website is scripted to provide accumulated patient reviews from patients of each medical provider who through a verification mechanism have indeed been seen and serviced by that medical provider as controlled by a survey mechanism.

5. The apparatus of claim 4, where the survey mechanism includes both 1) an assignment of a unique code to a survey given to the patient to complete as well as 2) a method of collecting the survey results from the patient, which combine as the verification mechanism to ensure that the patient reviews are coming from patients who have indeed been seen and serviced by that medical provider.

6. The apparatus of claim 4, where the method of collecting the survey results from the patient for the survey mechanism include patients can enter their randomly assigned code that the patient received in medical provider's office after the appointment into a webpage presented by the website in order to be brought to a separate webpage to complete a review of their last office visit, and
where the website is configured to assign a set of unique codes to the medical provider's office and store those assigned codes associated with a particular medical provider and then uses this stored information to verify that merely a select qualified group of people being the actual patients of the medical provider are providing the patient review information.

7. The apparatus of claim 3, where the medical providers' knowledge base and interaction website has a notice routine scripted to provide the medical provider periodically with emails that give an overview of the results of the patient reviews.

8. The apparatus of claim 1, where the medical providers' knowledge base and interaction website is configured to present a web page with a feature of an interactive human anatomy illustration, in which users may select areas that are hurting or need medical consultation on the interactive human anatomy illustration and then a pop up wizard will present questions to guide the user to find a type and specialty of the medical provider who the user should 1) make an appointment with, 2) types of medical providers in the plurality of medical providers to perform a search on and then populates at least a portion of the search criteria with known information about the user and information obtained from the interaction with the interactive human anatomy illustration, and 3) any combination of the two.

9. The apparatus of claim 1, where the medical providers' knowledge base and interaction website is configured to present a web page to use the search functionality to give an ability of the medical provider to compare himself/herself in the search criteria including 1) customer service rating of the medical provider, 2) overall ranking of the medical provider, 3) scoring in any particular category listed in the survey, and 4) the number of specific medical procedures performed and diseases treated, with one or more medical providers from the plurality, which the web page then displays the comparison data.

10. The apparatus of claim 1, where the medical providers' knowledge base and interaction website is configured to present a web page to use a histogram routine to give an ability to the medical provider to track their individual parameters and overall grade over time and compare himself/herself to their tracked history stored by a database cooperating with the website.

11. The apparatus of claim 1, where the medical providers' knowledge base and interaction website is configured to present a web page that cooperates with an interface mechanism to allow one or more of the medical providers to offer patients an ability to schedule appointments online via the website; and
a scheduling routine guides a user to be able to choose an earliest available time vacant for booking the scheduled appointment with one or more of the medical providers from the plurality of medical providers.

12. The apparatus of claim 1, where the medical providers' knowledge base and interaction website is configured to present a web page that at least one of 1) presents a phone number to call or 2) presents a field to solicit from the user to take in a phone number to call the user, in order for users to have a way to connect in near real time with a first medical provider from the plurality of medical providers via a phone call.

13. The apparatus of claim 1, where the medical providers' knowledge base and interaction website is configured to present a web page that has an adapter to Patient Management Software that allows the website to collect a patients' data on an automated basis and then store the patients' data in a cooperating database.

14. The apparatus of claim 1, where the medical providers' knowledge base and interaction website is configured to present a web page that provides a medical costs analysis section, where the webpage presents fields to solicit the following information and the user enters the information including a State where a medical procedure is to be performed, an Insurance plan of the user, a hospital where the medical procedure is to be performed, a name of the medical provider, and based on this information a cost routine will be able to provide prognostic data of an anticipated amount of medical costs to the user for that medical procedure.

15. A computer implemented method in a client-server environment, comprising:
serving one or more web pages to one or more clients connected over a network to a host server in order convey a medical provider's knowledge base and interaction website in the one or more web pages;
maintaining the medical provider's knowledge base and displaying information regarding a plurality of medical providers;
providing a search functionality on the data contained in the medical provider's knowledge base where a user of the website via a browser of a client device can search the knowledge base regarding the plurality of medical providers;
keeping track of 1) a total number of specific medical procedures done by first medical provider in the plurality of medical providers, 2) a number of specific medical procedures done by the first medical provider per set period of time, 3) a total number of specific diseases treated by the first medical provider, 4) a number of specific diseases the first medical provider has treated per set period of time, and 5) any combination of these, and where the specific medical procedures and the specific diseases treated are searchable criteria in a search routine implemented on the website as well as displayed information on one or more webpages regarding each medical provider in the plurality of medical providers, where the website and its functionality may be implemented with coded software, hardware circuits, and any combination of both, and where any portions of the website and its functionality implemented in coded software are stored in a non-transitory computer readable medium in format executable by a processing component.

16. The method of claim 15, further comprising:
providing a best match between a potential patient's needs, including at least 1) customer service rating of the medical provider, 2) ability for home visits by the medical provider, 3) insurance accepted by the medical provider, 4) overall ranking of the medical provider, 5) medical skills of the medical provider indicated by the number of specific medical procedures performed and diseases treated, and 6) any combination of and these criteria and each criteria may be weighted in importance in the search to affect the search results, to one or more medical provider's from the plurality who hold the skills required to address the user's problem;
and
providing patient reviews of a medical provider that are displayed on one or more web pages, where the medical provider is given time to rebut negative comments before those comments post on the web page, where the medical provider is given a period of time after a patient review comes in to look over content including scores in the patient review and post a rebuttal comment before the patient review is posted on-line, and where a content analyzing routine reviews content from the patient review and when the content analyzing routine detects 1) the negative comments 2) low scores, and 3) any combination of the two, the content analyzing routine initiates any of 1) an e-mail or 2) text message to be sent to the treating medical provider notifying that medical provider of the negative patient review, and where the medical provider's rebuttal comments are posted in a manner visually highlighting the rebuttal comments from the negative comments.

17. The method of claim 15, further comprising:
publishing accumulated patient reviews from patients of each medical provider who through a verification mechanism have indeed been seen and serviced by that medical provider as controlled by a survey mechanism; and
where the survey mechanism includes both 1) an assignment of a unique code to a survey given to the patient to complete as well as 2) a method of collecting the survey results from the patient, which combine as the verification mechanism to ensure that the patient reviews are coming from patients who have indeed been seen and serviced by that medical provider, where the published patient reviews affect a ranking of the medical provider against the plurality of medical providers.

18. The method of claim 15, further comprising:
publishing accumulated patient reviews from patients of each medical provider who through a verification mechanism have indeed been seen and serviced by that medical provider as controlled by a survey mechanism;
collecting survey results from the patients, where the survey mechanism allows patients to enter their randomly assigned code that the patient received in medical provider's office after the appointment into a webpage presented by the website in order to be brought to a separate webpage to complete a review of their last office visit;
where the website assigns a set of unique codes to each medical provider's office and stores those assigned codes to a particular medical provider and then uses this stored information to verify that merely a select qualified group of people being the actual patients of the medical provider are providing the patient review information, and
where the website scripts will also send a patient an email with a secure link to the website where they can complete the survey.

19. The method of claim 18, wherein when the patient does not respond to the email or otherwise does not fill in the survey information in a set period of time, then communicating to a call center pool to follow up with the patient to obtain the survey information.

20. The method of claim 17, further comprising:
publishing a web page to use the search functionality to give an ability of the medical provider to compare himself/herself in the search criteria including 1) customer service rating of the medical provider, 2) overall ranking of the medical provider, 3) scoring in any particular category listed in the survey, and 4) the number of specific medical procedures performed and diseases treated, with one or more medical providers from the plurality, where the web page then displays the comparison data; and
publishing a web page to use a histogram routine to give an ability to the medical provider to track their individual parameters and overall grade over time and compare himself/herself to their tracked history stored by a database cooperating with the website.
